(19) United States
(12) Patent Application Publication
(10) Pub. No.: US 2014/0160464 A1
(43) Pub. Date: Jun. 12, 2014

(54) TUBERCULOSIS SCREENING USING CPD DATA

(71) Applicant: Beckman Coulter, Inc., Brea, CA (US)

(72) Inventor: Kyungja Han, Seoul (KR)

(73) Assignee: Beckman Coulter, Inc., Brea, CA (US)

(21) Appl. No.: 13/965,773

(22) Filed: Aug. 13, 2013

Related U.S. Application Data
(60) Provisional application No. 61/731,654, filed on Nov. 30, 2012.

(51) Int. Cl. G01N 15/14

(52) U.S. Cl. CPC G01N 15/1436
USPC 356/39

(57) ABSTRACT

Embodiments of the present invention encompass automated systems and methods for predicting a tuberculosis infection in an individual based on a biological sample obtained from blood of the individual. Exemplary techniques involve correlating aspects of direct current (DC) impedance, radiofrequency (RF) conductivity, and/or light measurement data obtained from the biological sample with a prediction of Mycobacterium tuberculosis infection in the individual.

### CROSS-REFERENCES TO RELATED APPLICATIONS

This application claims the benefit of priority to U.S. Provisional Patent Application No. 61/731,654 filed Nov. 30, 2012, which is herein incorporated by reference in its entirety for all purposes. This application is also related to U.S. Pat. No. 8,094,299. The content of each of the above filings is incorporated herein by reference.

### BACKGROUND OF THE INVENTION

Embodiments of the present invention relate generally to the field of tuberculosis diagnosis and treatment, and in particular to systems and methods for identifying or predicting a Mycobacterium tuberculosis infection in an individual.

Pulmonary tuberculosis (or TB, an acronym for Tubercle Bacillus) is an infectious disease with airborne transmission that is associated with high morbidity and mortality worldwide. Despite recent advances in anti-tuberculosis medications, TB-associated mortality rates remain high in many developing countries. In South Korea, the incidence of TB is still high, particularly in individuals between twenty and thirty years of age. The most recently available data (2006) estimated at 18,000 the number of smear positive cases, and at 224,000 the number of radiologically active TB patients, totaling 0.36% of the population. Globally, it has been estimated that TB causes 1.7 million deaths each year, or approximately three deaths per minute.

Under currently used protocols, the diagnostic process for TB typically starts with the identification of clinical signs and symptoms, such as prolonged cough, lymphadenopathy, fevers, night sweats and weight loss. This clinical presentation, however, can overlap with the symptoms of several other medical conditions, and therefore studies probing into the predictive value of the typical initial presentation of TB have shown inconsistent results. This challenge is enhanced in HIV positive individuals, who are becoming an increasingly significant subset of TB patients and often have unusual or atypical presentations including a higher prevalence of extra-pulmonary TB, while at the same time being the patients who bear the worst consequences if the diagnosis is missed or delayed.

In the laboratory, the initial diagnosis of TB routinely relies on sputum acid fast bacilli (AFB) smear microscopy, solid or liquid mycobacterial cultures, and chest radiography. Sputum smear microscopy is commonly used in addition to cultures and provides results within days, but its main limitation is the low sensitivity, missing approximately half of cases. This is particularly concerning in both extrapulmonary TB and pleural TB. As a consequence, in South Korea only 11,638 (33.0%) of 35,269 newly diagnosed patients in 2006 were AFB smear positive. Conversely, mycobacterial cultures are the most sensitive diagnostic tests currently used for diagnosing TB. However, these tests require weeks for results to be obtained, which limits their utility and compromises the ability to diagnose, treat, and halt transmission of the disease.

New tests have recently been developed that increase the laboratory sensitivity in the diagnosis of TB. While studies have clearly demonstrated that PCR-based tests have higher sensitivity than AFB smear microscopy, the resources required to perform these tests remain beyond the reach of most patients in the developing countries where they are most needed. And besides economical limitations, most of these recently developed molecular methods require a sputum sample, thus limiting their applicability to patients with pulmonary disease who are able to provide sputum for analysis.

Examples of other newly developed laboratory tests for the diagnosis of TB include QuantiFERON®-TB Gold and interferon-gamma ELISpot, which have important advantages since they are performed on peripheral blood instead of sputum, and can detect both latent and active infection. However, the costs of these tests may also be prohibitive in most of the countries where tuberculosis is today a serious public health burden.

Finally, all the laboratory tests discussed above are disease-specific tests, and therefore will be performed when there already is strong clinical suspicion so that the treating physician starts a TB work-up. This means the diagnosis is made late in the disease process when the patient already had ample opportunity to contaminate others in public spaces, and when the risks of long term morbidity and mortality are higher.

Hence, although tuberculosis analysis systems and methods are currently available and provide real benefits to patients in need thereof, many advances may still be made to provide improved devices and methods for assessing or predicting a tuberculosis infection state or status in an individual. For example, some current analysis systems are prohibitively expensive or do not provide results within a clinically useful timeframe. Relatedly, in some cases, existing techniques may not be readily available in routine laboratories, particularly in developing nations. In some instances, the start of therapy may be delayed for several days or weeks until diagnostic results become available following the initial tests. In some instances, current techniques may be nonspecific in diagnosing TB, particularly in the early stages of the infection. Embodiments of the present invention provide solutions that address these problems, and hence provide answers to at least some of these outstanding needs.

### BRIEF SUMMARY OF THE INVENTION

Embodiments of the present invention provide improved techniques for predicting a tuberculosis (TB) infection state or status in an individual. Such predictive techniques can employ various combinations of traditional Complete Blood Cell Count differential parameters in addition to certain morphological parameters, so as to provide reliable screening approaches that identify tuberculosis patients in the general population. For example, diagnostic systems and methods can provide an early and accurate prediction as to whether an individual has a Mycobacterium tuberculosis infection or not. In some instances, a TB decision rule or hemeprint can be used to help screen or identify TB infected individuals from among a large population of unsuspected individuals undergoing common medical examination procedures, such as routine CBC differential testing. In this way, TB infections can be identified before the onset of overt symptomatology. Moreover, even where such screening methods may flag individuals as having TB when in fact they do not (i.e. false positive cases), such individuals may instead present with a non-TB medical condition that itself benefits from the increased diagnostic scrutiny brought about by TB screening techniques disclosed herein.

Hence, whereas many current TB-specific tests are performed only after an individual presents with clinical signs and symptoms of a TB infection, embodiments of the present invention encompass systems and methods for predicting tuberculosis infection using automated hematology analysis as part of a routine patient examination. For example, standard blood samples from patients who come under the care of a physician can be evaluated using a hematology system that is equipped to obtain multiple light angle detection parameters, such as Beckman Coulter's UniCel® DxH™ 800 Cellular Analysis System. By employing the techniques disclosed herein, hematopathologists and clinicians can better predict disease prognosis for each individual patient, assess the likelihood of future complications, and quickly and accurately tailor the therapy offered to the tuberculosis patient.

The DxH 800 hematology analyzer is able to directly recognize morphologic features indicative of the main sub-types of white blood cells (WBCs) and thus generate a differential count. As discussed elsewhere herein, this technology simultaneously collects data on various parameters that are directly correlated to cellular morphology. As WBCs are analyzed, they can be plotted in tri-dimensional histograms with their position being defined by various parameters. For each of these parameters, the instrument can grade the cell in a range from 1 to 256 points. Since WBCs of the same sub-type (granulocytes, lymphocytes, monocytes, eosinophils, basophils) will have similar morphologic features, they can be plotted in similar regions of the tri-dimensional histogram, thus forming cell populations. The number of events in each population can be used to generate a differential count. Besides the differential count, for each of the WBC sub-populations, the mean and standard deviation values for the points of each of these morphologic parameters (volume, conductivity, and five angles of light scatter) can be calculated separately. As a result, a vast amount of data directly correlating to WBC morphology is generated. This information can be called collectively “Cell Population Data” (CPD), and it can be viewed on the screen of the instrument, as well as automatically exported as an Excel file. Embodiments of the present invention may include evaluating a biological sample from an individual by obtaining a cell population data profile for the biological sample, assigning a Mycobacterium tuberculosis infection status indication to the biological sample based on the cell population data profile, and outputting the assigned Mycobacterium tuberculosis infection indication. One or more of these steps may be performed by a hematology analyzer such as Beckman Coulter's UniCel® DxH™ 800 Cellular Analysis System.

Tuberculosis is associated with a significant activation of the immunological system, which in turn leads to the release of several cytokines that can affect the morphology of WBCs. Hematological morphologic changes in patients with TB can be used to screen the general population for this disease at the time of a routine CBC-diff or other blood analysis procedure, thus allowing for an early diagnosis before the onset of overt clinical signs and symptoms. Multiparametric CPD models have been developed that combine information from several of the morphologic parameters described herein, in addition to the traditional parameters regularly reported in the CBC-diff. The performance of such models in screening the general population for TB has been tested. The burden of false-positive screened cases has also been evaluated, and other medical conditions were evaluated that could mimic TB as identified by these screening models.

Embodiments of the present invention provide quick and accurate tuberculosis screening results. Using the approaches disclosed herein, it is possible to evaluate and predict a tuberculosis infection in an individual, using information obtained from a multi-parametric cellular analysis system. As disclosed herein, exemplary cellular analysis systems can simultaneously measure parameters such as volume, conductivity, and/or multiple angles of light scatter. Such systems provide a high degree of resolution and sensitivity for implementing cellular analysis techniques. In some instances, cellular analysis systems detect light scatter at three, four, five, or more angular ranges. Additionally, cellular analysis systems also can detect signals at an angle between 0° to about 1° from the incident light, which corresponds to a light extinction parameter known as axial light loss. As a non-limiting example, Beckman Coulter's UniCel® DxH™ 800 Cellular Analysis System provides light scatter detection data for multiple angles (e.g. between 0°-0.5° for AL2, about 5.1° for LALS, between 9°-19° for LMALS, and between 20°-43° for UMALS). These techniques allow for fast, accurate diagnosis and treatment of patients infected with Mycobacterium tuberculosis, particularly in situations where more modern tests are not readily available.

Such hematology analysis instruments can evaluate more than 8,000 cells in a matter of seconds, and the morphologic features of cellular volume, cytoplasmic granularity, nuclear complexity, and internal density can be evaluated quantitatively, for example via a point system which can be referred to as cell population data. Numerical decision rules can be generated and used to implement screening strategies for predicting a tuberculosis infection state or status in an individual.

Hence, embodiments of the present invention encompass systems and methods for the diagnosis of tuberculosis infection using multiparametric models for disease classification. Patterns of morphological change can be analyzed by combining information from various measured parameters. What is more, by using ratios of parameters, instead of or in addition to the raw values of the parameters themselves, it is possible to introduce internal controls into data sets. Such control techniques can be particularly useful from the laboratory point of view, as it can provide an enhancement of calibration and quality control for cellular analysis systems.

All features of the described systems are applicable to the described methods mutatis mutandis, and vice versa.

In one aspect, embodiments of the present invention encompass automated systems and methods for predicting a tuberculosis infection in an individual based on a biological sample obtained from blood of the individual. In some instances, the tuberculosis infection can be a result of exposure to the Mycobacterium tuberculosis organism. Exemplary systems include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone so as to measure light scattered by and transmitted through the irradiated cells of the biological sample. The light detection assembly may be configured to measure a first propagated light from the irradiated cells within a first range of relative to the light beam axis, a second propagated light from the irradiated cells within a second range of angles relative to the light beam axis, the second range being different than the first range, and an axial light propagated from the irradiated cells along the beam axis. The system may be configured to correlate a subset of DC impedance, RF conductivity, the first propagated light, the second propagated light, and the axial light measurements from the cells of the biological sample with a tuberculosis infection of the individual. In some instances, the light detection assembly includes a first sensor zone that measures the first propagated light, a second sensor zone that measures the second propagated light, and a third sensor zone that measures the axial propagated light. In some instances, the light detection assembly may include a first sensor that measures the first propagated light, a second sensor that measures the second propagated light, and a third sensor that measures the axial propagated light. In some instances of the systems and methods of the invention the subset comprises DC impedance measurements for neutrophils, lymphocytes, monocytes, eosinophils, and non-nucleated red blood cells of the biological sample. In some instances of the systems and methods of the invention the subset comprises RF conductivity measurements for neutrophils, lymphocytes, eosinophils, and non-nucleated red blood cells of the biological sample. The system may be configured to correlate a subset of Complete Blood Cell Count measurements from the cells of the biological sample combined with the subset of DC impedance, RF conductivity, the first propagated light, the second propagated light, and the axial light measurements with the prediction of Mycobacterium tuberculosis infection in the individual. Similarly, in the methods of the invention, a subset of Complete Blood Cell Count measurements from the cells of the biological sample combined with the subset of DC impedance, RF conductivity, the first propagated light, the second propagated light, and the axial light measurements may be correlated with the prediction of Mycobacterium tuberculosis infection in the individual. In some instances of the systems and methods of the invention, the individual has a White Blood Cell Count of less than or equal to 6,000 per microliter of blood, and wherein the subset comprises a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. In other instances, wherein the individual has a White Blood Cell Count of greater than 6,000 per microliter of blood, the subset may comprise a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. In some instances of the systems and methods of the invention wherein the individual has a White Blood Cell Count of less than or equal to 6,000 per microliter of blood, the subset includes a neutrophil calculated parameter comprising a member selected from the group consisting of: a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. In some instances of the systems and methods of the invention wherein the individual has a White Blood Cell Count greater than 6,000 per microliter of blood, the subset includes a neutrophil calculated parameter comprising a member selected from the group consisting of: a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, the system is configured to correlate a subset of Complete Blood Cell Count measurements from the cells of the biological sample combined with the subset of DC impedance, RF conductivity, the first propagated light, the second propagated light, and the axial light measurements with the prediction of Mycobacterium tuberculosis infection in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass methods for predicting a Mycobacterium tuberculosis infection status of an individual based on a biological sample obtained from blood of the individual. Exemplary methods may include delivering a hydrodynamically focused stream of the biological sample toward a cell interrogation zone of an optical element, measuring, with an electrode assembly, current (DC) impedance and radiofrequency (RF) conductivity of cells of the biological sample passing individually through the cell interrogation zone, irradiating, with an electromagnetic beam having an axis, cells of the biological sample individually passing through the cell interrogation zone, measuring, with an electromagnetic radiation detection assembly, a first propagated electromagnetic radiation from the irradiated cells within a first range of relative to the beam axis, measuring, with the electromagnetic radiation detection assembly, a second propagated electromagnetic radiation from the irradiated cells within a second range of angles relative to the beam axis, the second range being different than the first range, measuring, with the electromagnetic radiation detection assembly, axial electromagnetic radiation propagated from the irradiated cells along the beam axis, and correlating a subset of DC impedance, RF conductivity, the first propagated electromagnetic radiation, the second propagated electromagnetic radiation, and the axial electromagnetic radiation measurements from the cells of the biological sample with a predicted Mycobacterium tuberculosis infection status of the individual. In some instances, the subset includes a calculated parameter, the calculated parameter is based on a function of at least two measures of cell population data, and the Mycobacterium tuberculosis infection status is assigned based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). As described herein, light may refer to a type of electromagnetic radiation. Relatedly, the light scatter or loss parameters discussed here may also be replaced with corresponding electromagnetic radiation scatter or loss parameters. In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the electromagnetic radiation detection assembly includes a first sensor zone that measures the first propagated electromagnetic radiation, a second sensor zone that measures the second propagated electromagnetic radiation, and a third sensor zone that measures the axial propagated electromagnetic radiation. In some instances, the electromagnetic radiation detection assembly may include a first sensor that measures the first propagated electromagnetic radiation, a second sensor that measures the second propagated electromagnetic radiation, and a third sensor that measures the axial propagated electromagnetic radiation. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, the method includes correlating a subset of Complete Blood Cell Count measurements from the cells of the biological sample combined with the subset of DC impedance, RF conductivity, the first propagated electromagnetic radiation, the second propagated electromagnetic radiation, and the axial electromagnetic radiation measurements with the prediction of Mycobacterium tuberculosis infection in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light or electromagnetic radiation loss measurement of the sample, an upper median angle light or electromagnetic radiation scatter measurement of the sample, a low frequency current measurement of the sample, a low angle light or electromagnetic radiation scatter measurement of the sample, a lower median angle light or electromagnetic radiation scatter measurement of the sample, and a median angle light or electromagnetic radiation scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light or electromagnetic radiation loss measurement of the sample, an upper median angle light or electromagnetic radiation scatter measurement of the sample, a low frequency current measurement of the sample, a low angle light or electromagnetic radiation scatter measurement of the sample, a lower median angle light or electromagnetic radiation scatter measurement of the sample, and a median angle light or electromagnetic radiation scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light or electromagnetic radiation loss measurement, a ratio of a neutrophil upper median angle light or electromagnetic radiation scatter measurement to a neutrophil low frequency current measurement, a ratio of a neutrophil low angle light or electromagnetic radiation scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light or electromagnetic radiation scatter measurement to a neutrophil axial light or electromagnetic radiation loss measurement, a ratio of a neutrophil median angle light or electromagnetic radiation scatter measurement to a neutrophil axial light or electromagnetic radiation loss measurement, a ratio of a neutrophil low angle light or electromagnetic radiation scatter measurement to a neutrophil axial light or electromagnetic radiation loss measurement, a ratio of a neutrophil high frequency current measurement to a neutrophil axial light or electromagnetic radiation loss measurement, a ratio of a neutrophil low angle light or electromagnetic radiation scatter measurement to a neutrophil low frequency current measurement, a ratio of a neutrophil high frequency current measurement to a neutrophil low frequency current measurement, and a ratio of a neutrophil upper median angle light or electromagnetic radiation scatter measurement to a neutrophil median angle light or electromagnetic radiation scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass methods of evaluating a biological sample from an individual. Exemplary methods include obtaining a cell population data profile for the biological sample, assigning a Mycobacterium tuberculosis infection status indication to the biological sample based on the cell population data profile, and outputting the assigned Mycobacterium tuberculosis infection status indication. The cell population data profile may include light scatter data, light absorption data, and/or current data. According to some embodiments, a cell population data profile may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is assigned based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, the method includes correlating a subset of Complete Blood Cell Count measurements from the cells of the biological sample combined with the subset of DC impedance, RF conductivity, the first propagated light, the second propagated light, and the axial light measurements with the assigned Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In still another aspect, embodiments of the present invention encompass automated systems for predicting a Mycobacterium tuberculosis infection status of an individual based on a biological sample obtained from the individual. Exemplary systems include a conduit configured to receive and direct movement of the biological sample thorough an aperture, a light scatter and absorption measuring device configured to emit light through the biological sample as it moves through the aperture and collect data concerning scatter and absorption of the light, and a current measuring device configured to pass an electric current through the biological sample as it moves through the aperture and collect data concerning the electric current. The system may be configured to correlate the data concerning scatter and absorption of the light and the data concerning the electric current with a Mycobacterium tuberculosis infection status of the individual. According to some embodiments, the light scatter data, light absorption data, and/or current data may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass automated systems for predicting a Mycobacterium tuberculosis infection status of an individual based on a biological sample obtained from the individual. Exemplary systems may include a transducer for obtaining light scatter data, light absorption data, and current data for the biological sample as the sample passes through an aperture, a processor, and a storage medium having a computer application that, when executed by the processor, is configured to cause the system to use the light scatter data, the light absorption data, the current data, or a combination thereof, to determine a predicted Mycobacterium tuberculosis infection status of the individual, and to output from the processor information relating to the predicted Mycobacterium tuberculosis infection status. According to some embodiments, the light scatter data, light absorption data, and/or current data may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass automated systems for predicting a Mycobacterium tuberculosis infection status of an individual based on a biological sample obtained from the individual. Exemplary systems may include a transducer for obtaining cell population data for the biological sample as the sample passes through an aperture, a processor, and a storage medium having a computer application that, when executed by the processor, is configured to cause the system to use the cell population data to determine a predicted Mycobacterium tuberculosis infection status of the individual, and to output from the processor information relating to the predicted Mycobacterium tuberculosis infection status.

In yet another aspect, embodiments of the present invention encompass automated systems for identifying if an individual may have a Mycobacterium tuberculosis infection based on a biological sample obtained from the individual. Exemplary systems may include a transducer for obtaining light scatter data, light absorption data, and current data for the biological sample as the sample passes through an aperture, a processor, and a storage medium having a computer application that, when executed by the processor, is configured to cause the system to use a calculated parameter, which is based on a function of at least two measures of the light scatter data, light absorption data, or current data, to determine a predicted Mycobacterium tuberculosis infection status of the individual, and to output from the processor tuberculosis information relating to the identified Mycobacterium tuberculosis infection of the individual. According to some embodiments, the light scatter data, light absorption data, and/or current data may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection is identified based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the identified Mycobacterium tuberculosis infection in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass methods of evaluating a biological sample obtained from an individual. Exemplary methods may include passing the biological sample through an aperture of a particle analysis system, obtaining light scatter data, light absorption data, and current data for the biological sample as the sample passes through the aperture, determining a cell population data profile for the biological sample based on the light scatter data, the light absorption data, the current data, or a combination thereof, assigning a Mycobacterium tuberculosis infection status indication to the biological sample based on the cell population data profile, and outputting the assigned Mycobacterium tuberculosis infection status indication. According to some embodiments, the light scatter data, light absorption data, and/or current data may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status indication is assigned based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, methods can include correlating a subset of Complete Blood Cell Count measurements from the cells of the biological sample combined with the subset of DC impedance, RF conductivity, the first propagated light, the second propagated light, and the axial light measurements with the assigned Mycobacterium tuberculosis infection status indication in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In yet another aspect, embodiments of the present invention encompass automated methods of evaluating a biological sample from an individual. Exemplary methods may include obtaining, using a particle analysis system, light scatter data, light absorption data, and current data for the biological sample as the sample passes through an aperture, determining a cell population data profile for the biological sample based on assay results obtained from the particle analysis system, determining, using a computer system, a Mycobacterium tuberculosis infection physiological status for the individual according to a calculated parameter, where the calculated parameter is based on a function of at least two cell population data measures of the cell population data profile, and outputting the Mycobacterium tuberculosis infection physiological status. According to some embodiments, the light scatter data, light absorption data, and/or current data may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection physiological status indication is determined based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, methods can include correlating a subset of Complete Blood Cell Count measurements from the cells of the biological sample combined with the subset of DC impedance, RF conductivity, the first propagated light, the second propagated light, and the axial light measurements with the determined Mycobacterium tuberculosis infection physiological status indication in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass automated systems for predicting a Mycobacterium tuberculosis infection status of an individual. Exemplary systems may include a processor, and a storage medium comprising a computer application that, when executed by the processor, is configured to cause the system to access information concerning a biological sample of the individual, including information relating at least in part to an axial light or electromagnetic radiation loss measurement of the sample, a light or electromagnetic radiation scatter measurement of the sample, a current measurement of the sample, or a combination of two or more thereof, to use the information relating at least in part to the axial light or electromagnetic radiation loss measurement, the plurality of light or electromagnetic radiation scatter measurements, the current measurement, or the combination thereof, to determine a predicted Mycobacterium tuberculosis infection status of the individual, and to output from the processor information relating to the predicted Mycobacterium tuberculosis infection status. In some instances, the current measurement includes a low frequency current measurement of the sample, a high frequency current measurement of the sample, or a combination thereof. In some instances, the light or electromagnetic radiation scatter measurement includes a low angle light or electromagnetic radiation scatter measurement, a lower median angle light or electromagnetic radiation scatter measurement, an upper median angle light or electromagnetic radiation scatter measurement, or a combination of two or more thereof. In some instances, a system may also include an electromagnetic beam or light source and a photosensor assembly, where the photosensor assembly is used to obtain the axial light or electromagnetic radiation loss measurement. In some instances, a system may also include an electromagnetic beam or light source and a photosensor assembly, where the photosensor assembly is used to obtain the light or electromagnetic radiation scatter measurement. In some instances, a system may also include an electromagnetic beam or light source and an electrode assembly, where the electrode assembly is used to obtain the current measurement. As discussed herein, electromagnetic radiation may encompass multiple types of energy, including for example light. Relatedly, light can be considered as one type of electromagnetic radiation. Further, where light is mentioned, it is understood that in some embodiments the term may be substituted with electromagnetic radiation. Similarly, where electromagnetic radiation is mentioned, it is understood that in some embodiments the term may be substituted with light. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass an automated system for predicting a Mycobacterium tuberculosis infection status of an individual. Exemplary systems may include a processor, and a storage medium having a computer application that, when executed by the processor, is configured to cause the system to access cell population data concerning a biological sample of the individual, to use the cell population data to determine a predicted Mycobacterium tuberculosis infection status of the individual, and to output from the processor information relating to the predicted Mycobacterium tuberculosis infection status. In some instances, the processor is configured to receive the cell population data as input. In some instances, the processor, the storage medium, or both, are incorporated within a hematology machine. In some instances, the hematology machine generates the cell population data. In some instances, the processor, the storage medium, or both, are incorporated within a computer, and the computer is in communication with a hematology machine. In some instances, the hematology machine generates the cell population data. In some instances, the processor, the storage medium, or both, are incorporated within a computer, and the computer is in remote communication with a hematology machine via a network. In some instances, the hematology machine generates the cell population data. In some instances, the cell population data includes a member selected from the group consisting of an axial light loss measurement of the sample, a light scatter measurement of the sample, and a current measurement of the sample. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In still yet another aspect, embodiments of the present invention encompass automated systems for evaluating the physiological status of an individual. Exemplary systems may include a processor, and a storage medium having a computer application that, when executed by the processor, is configured to cause the system to access cell population data concerning a biological sample of the individual, to use a calculated parameter, which is based on function of at least two measures of the cell population data, to determine the physiological status of the individual, the determined physiological status providing an indication whether the individual has a Mycobacterium tuberculosis infection, and to output from the processor information relating to the physiological status of the individual. In some instances, the processor is configured to receive the cell population data as input. In some instances, the processor, the storage medium, or both, are incorporated within a hematology machine. In some instances, the hematology machine generates the cell population data. In some instances, the processor, the storage medium, or both, are incorporated within a computer, and the computer is in communication with a hematology machine. In some instances, the hematology machine generates the cell population data. In some instances, the processor, the storage medium, or both, are incorporated within a computer, and the computer is in remote communication with a hematology machine via a network. In some instances, the hematology machine generates the cell population data. In some instances, the cell population data includes a member selected from the group consisting of an axial light loss measurement of the sample, a light scatter measurement of the sample, and a current measurement of the sample. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection indication is provided based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the Mycobacterium tuberculosis infection indication in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass automated systems for identifying if an individual may have a Mycobacterium tuberculosis infection from hematology system data. Exemplary systems may include a processor, and a storage medium having a computer application that, when executed by the processor, is configured to cause the system to access hematology cell population data concerning a blood sample of the individual, to use a calculated parameter, which is based on a function of at least two measures of the hematology cell population data, to determine a predicted Mycobacterium tuberculosis infection status of the individual, and to output from the processor tuberculosis information relating to the predicted Mycobacterium tuberculosis infection status of the individual. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection is identified based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the identified Mycobacterium tuberculosis infection in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In still another aspect, embodiments of the present invention encompass automated methods of evaluating a biological sample from an individual. Exemplary methods may include determining a cell population data profile for the biological sample based on assay results obtained from a particle analysis system analyzing the sample, determining, using a computer system, a physiological status for the individual according to a calculated parameter, where the calculated parameter is based on a function of at least two cell population data measures of the cell population data profile, and where the physiological status provides an indication whether the individual has a Mycobacterium tuberculosis infection, and outputting the physiological status. According to some embodiments, the cell population data profile may include light scatter data, light absorption data, current data, or a combination thereof. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, methods can include correlating a subset of Complete Blood Cell Count measurements from the cells of the biological sample combined with the subset of DC impedance, RF conductivity, the first propagated light, the second propagated light, and the axial light measurements with the Mycobacterium tuberculosis infection indication in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass methods of determining a treatment regimen for an individual. Exemplary methods may include accessing a cell population data profile concerning a biological sample of the patient, determining, using a computer system, a predicted Mycobacterium tuberculosis infection status for the patient based on the cell population data profile, and determining the treatment regimen for the patient based on the predicted Mycobacterium tuberculosis infection status. In some instances, the step of determining the predicted Mycobacterium tuberculosis infection status includes using a calculated parameter, and the calculated parameter is based on a function of at least two cell population data measures. According to some embodiments, the cell population data profile may include light scatter data, light absorption data, current data, or a combination thereof. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, methods can include correlating a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In another aspect, embodiments of the present invention encompass methods of determining a treatment regimen for an individual. Exemplary methods may include accessing a cell population data profile concerning a biological sample of the individual, determining, using a computer system, a physiological status for the individual according to a calculated parameter, where the calculated parameter is based on a function of at least two cell population data measures of the cell population data profile, and where the physiological status corresponds to a Mycobacterium tuberculosis infection status, and determining the treatment regimen for the individual based on the a physiological status for the individual. According to some embodiments, the cell population data profile may include light scatter data, light absorption data, current data, or a combination thereof. According to some embodiments, the light scatter measurement, light absorption measurement, and/or current measurement may include a subset of DC impedance, RF conductivity, first propagated light, second propagated light, and axial light measurements from the cells of the biological sample. In some instances, the subset includes a calculated parameter, and the calculated parameter is based on a function of at least two measures of cell population data, and the Mycobacterium tuberculosis infection status is determined based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, methods can include correlating a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

In yet another aspect, embodiments of the present invention encompass automated systems for predicting a Mycobacterium tuberculosis infection status of an individual based on a biological sample obtained from blood of the individual. Exemplary systems may include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone. The light detection assembly may include a first sensor region disposed at a first location relative to the cell interrogation zone that detects a first propagated light, a second sensor region disposed at a second location relative to the cell interrogation zone that detects a second propagated light, and a third sensor region disposed at a third location relative to the cell interrogation zone that detects an axial propagated light. The system may be configured to correlate a subset of DC impedance, RF conductivity, the first propagated light, the second propagated light, and the axial light measurements from the cells of the biological sample with a Mycobacterium tuberculosis infection status of the individual. In some instances, the subset includes a calculated parameter, and the calculated parameter is based on a function of at least two measures of cell population data, and the Mycobacterium tuberculosis infection status is predicted based at least in part on the calculated parameter. In some instances, the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the subset includes a neutrophil calculated parameter (NE), a lymphocyte calculated parameter (LY), a monocyte calculated parameter (MO), an eosinophil calculated parameter (EO), or a non-nucleated red blood cell calculated parameter (NNRBC). In some instances, the subset is determined based on a pre-defined specificity for tuberculosis. In some instances, the subset is determined based on a pre-defined sensitivity for tuberculosis. In some instances, the subset includes a calculated parameter for identifying tuberculosis. In some instances, the prediction can also be based on a Complete Blood Cell Count parameter in combination with other CPD and calculated parameters. In some instances, the subset includes DC impedance measurements for neutrophils, lymphocytes, monocytes, eosinophils, and non-nucleated red blood cells of the biological sample. In some instances, the subset includes RF conductivity measurements for neutrophils, lymphocytes, eosinophils, and non-nucleated red blood cells of the biological sample. According to some embodiments, systems can be configured to correlate a subset of Complete Blood Cell Count measurements from the cells of the biological sample combined with the subset of DC impedance, RF conductivity, the first propagated light, the second propagated light, and the axial light measurements with the predicted Mycobacterium tuberculosis infection status in the individual. According to some embodiments, where the individual has a White Blood Cell Count of less than or equal to 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of greater than 6,000 per microliter of blood, the subset can include a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample. According to some embodiments, where the individual has a White Blood Cell Count of less than or equal to 6,000 per microliter of blood, the subset can include a neutrophil calculated parameter comprising a member selected from the group consisting of a ratio of a neutrophil high frequency current measurement to a neutrophil axial light loss measurement, a ratio of a neutrophil upper median angle light scatter measurement to a neutrophil low frequency current measurement, a ratio of a neutrophil low angle light scatter measurement to a neutrophil low frequency current measurement, and a ratio of a neutrophil high frequency current measurement to a neutrophil low frequency current measurement. According to some embodiments, where the individual has a White Blood Cell Count greater than 6,000 per microliter of blood, the subset can include a neutrophil calculated parameter comprising a member selected from the group consisting of a ratio of a neutrophil upper median angle light scatter measurement to a neutrophil axial light loss measurement, a ratio of a neutrophil median angle light scatter measurement to a neutrophil axial light loss measurement, a ratio of a neutrophil low angle light scatter measurement to a neutrophil axial light loss measurement, a ratio of a neutrophil high frequency current measurement to a neutrophil axial light loss measurement, a ratio of a neutrophil low angle light scatter measurement to a neutrophil low frequency current measurement, a ratio of a neutrophil high frequency current measurement to a neutrophil low frequency current measurement, and a ratio of a neutrophil upper median angle light scatter measurement to a neutrophil median angle light scatter measurement. In some cases, the subset is determined based on a pre-defined specificity for tuberculosis. In some cases, the subset is determined based on a pre-defined sensitivity for tuberculosis. In some cases, the subset includes a calculated parameter for identifying tuberculosis. In some instances, the biological sample comprises a blood sample of the individual. In some instances, the biological sample includes neutrophils, lymphocytes, monocytes, eosinophils, and non-nucleated red blood cells (or leukocytes or WBCs) of the individual.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this Summary. This Summary is a high-level overview of various aspects of the invention and introduces some of the concepts that are further described in the Detailed Description section below. This Summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The above described and many other features and attendant advantages of embodiments of the present invention will become apparent and further understood by reference to the following detailed description when considered in conjunction with the accompanying drawings.

### BRIEF DESCRIPTION OF THE DRAWINGS

FIG. 1 provides a schematic diagram of tuberculosis infection and screening, according to embodiments of the present invention.

FIG. 2 schematically depicts aspects of a cellular analysis system, according to embodiments of the present invention.

FIG. 3 provides a system block diagram illustrating aspects of a cellular analysis system according to embodiments of the present invention.

FIG. 4 illustrates aspects of an automated cellular analysis system for predicting a acute Mycobacterium tuberculosis infection status of an individual, according to embodiments of the present invention.

FIG. 4A shows aspects of an optical element of a cellular analysis system, according to embodiments of the present invention.

FIG. 5 depicts aspects of an exemplary method for predicting a Mycobacterium tuberculosis infection status of an individual, according to embodiments of the present invention.

FIG. 6 provides a simplified block diagram of an exemplary module system, according to embodiments of the present invention.

FIG. 7 depicts an exemplary screen shot of a differential count screen, according to embodiments of the present invention.

FIG. 7A schematically shows a technique for obtaining CPD parameters, according to embodiments of the present invention.

FIG. 8 illustrates aspects of a method for obtaining and using a decision rule, according to embodiments of the present invention.

FIGS. 9 (i & ii) and 9A show aspects of blood cell parameters according to embodiments of the present invention.

FIG. 10 depicts aspects of decision rule techniques according to embodiments of the present invention.

FIG. 11 depicts aspects of decision rule techniques according to embodiments of the present invention.

FIG. 12A shows a cluster analysis image corresponding to sample data according to embodiments of the present invention.

FIG. 12B depicts aspects of decision rule techniques according to embodiments of the present invention.

FIGS. 13A (i, ii, & iii), 13B (i & ii), 13C (i & ii), 13D (i, ii, & iii), 13E (i, ii, & iii), and 13F (i, ii, & iii) illustrate aspects of decision rule techniques according to embodiments of the present invention.

### DETAILED DESCRIPTION OF THE INVENTION

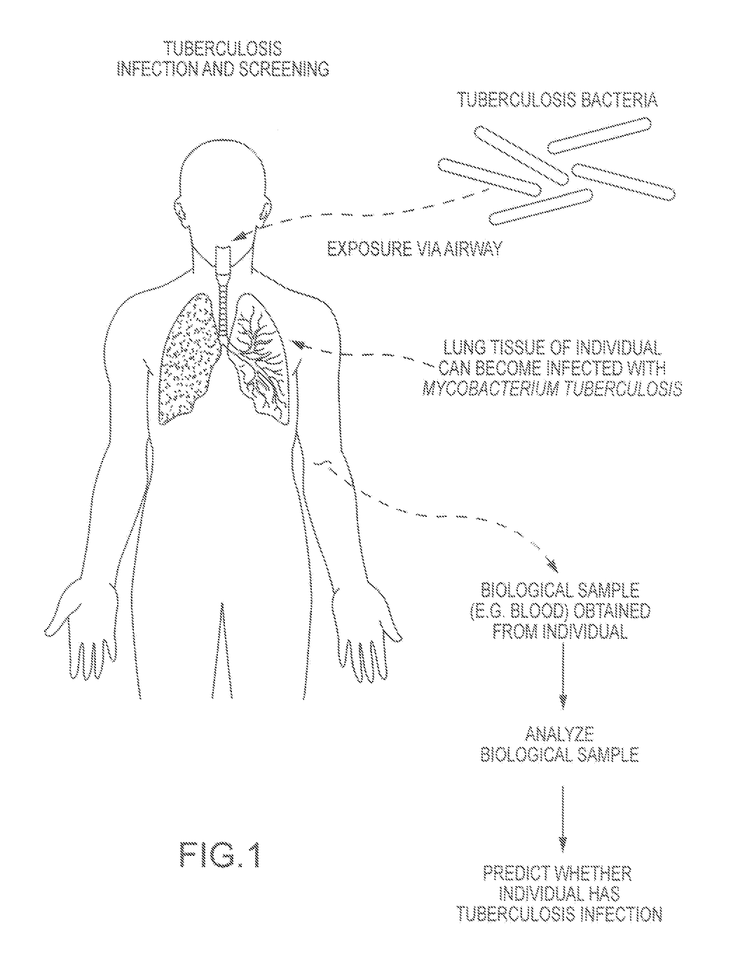

Described herein are hematology systems and methods configured to predict a tuberculosis infection status of an individual, based on a biological sample obtained from the individual. FIG. 1 provides a schematic diagram of tuberculosis exposure and infection events which may occur with a human individual. Typically, tuberculosis is transmitted from one individual to another via airborne particles (e.g. infectious aerosolized droplets expelled by coughing). Upon exposure to the infectious particles, the individual may develop a tuberculosis infection. The causal organism can be any of a variety of Mycobacterium tuberculosis strains. Typically, the infection occurs within pulmonary tissue of the individual, although other parts of the body may be affected. The hematology systems and methods discussed herein can predict whether an individual is infected with tuberculosis based on data related to certain impedance, conductivity, and angular light propagation measurements of a biological sample of the individual.

Cellular analysis systems that detect light scatter at multiple angles can be used to analyze a biological sample (e.g. a blood sample) and output a predicted Mycobacterium tuberculosis infection status of an individual. For example, an infection status may be positive thus indicating that the individual is predicted to have a Mycobacterium tuberculosis infection. Conversely, an infection status may be negative thus indicating that the individual is predicted to not have a Mycobacterium tuberculosis infection. In some cases, a predicted infection status may refer to the stage of an infection (e.g. active versus latent). Exemplary systems are equipped with sensor assemblies that obtain light scatter data for three or more angular ranges, in addition to light transmission data associated with an extinction or axial light loss measure, and thus provide accurate, sensitive, and high resolution results without requiring the use of certain dye, antibody, or fluorescence techniques. In one instance, a hematology analyzer such as a DxH 800 Hematology Analyzer (Beckman Coulter, Brea, Calif., USA) is configured to analyze a biological sample (e.g. a blood sample) based on multiple light scatter angles and output a predicted Mycobacterium tuberculosis infection status of an individual. The DxH 800 includes a WBC channel processing module that is configured to recognize the morphologic features indicative of the main sub-types of White Blood Cells (WBCs) and generate a differential count. Specifically, there are five types of leukocytes (white blood cells). A leukocyte differential count, or WBC differential, indicates the relative proportion of each of the cell types in a biological sample. A WBC differential typically includes counts or percentages for neutrophils, lymphocytes, monocytes, eosinophils, and basophils. Relatedly, the DxH includes an nRBC channel processing module that is configured to analyze leukocytes. The DxH 800 is also configured to generate a significant amount of additional data based on analysis of the sample, this additional data, which is described in more detail below, is referred to as Cell Population Data (CPD).

In some embodiments, the differential count and cell population data is based on the determination of 7 different parameters for each cell of the sample analyzed, such parameters correlating to each cell's morphology. Specifically, a volume parameter corresponding to the cell size can be measured directly by impedance. Further, a conductivity parameter corresponding to the internal cellular density can be measured directly by the conduction of radio frequency waves across the cell. What is more, five different angles (or ranges of angles) of light scatter corresponding to cytoplasmic granularity and nuclear complexity, for example, can be measured with various light detection mechanisms.

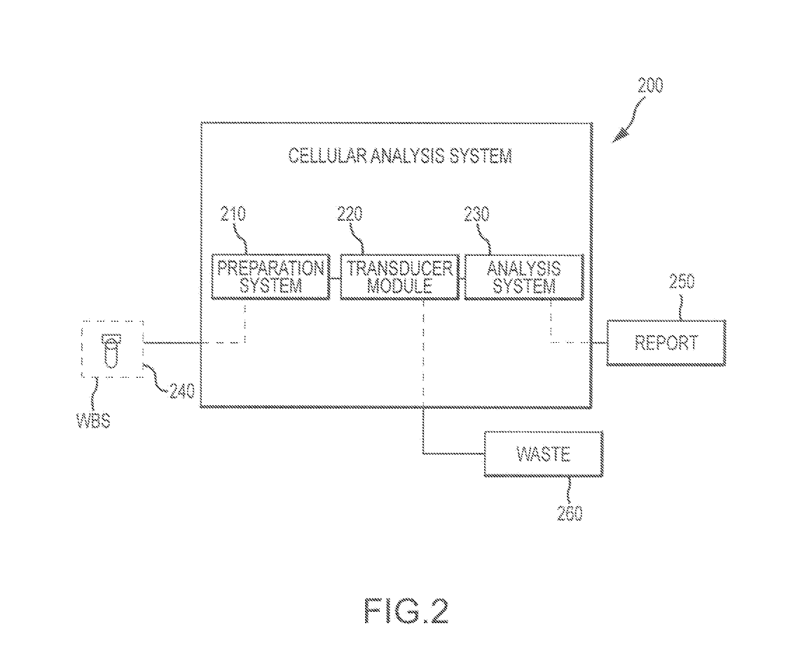

FIG. 2 schematically depicts a cellular analysis system 200. As shown here, system 200 includes a preparation system 210, a transducer module 220, and an analysis system 230. While system 200 is herein described at a very high level, with reference to the three core system blocks (210, 220, and 230), one of skill in the art would readily understand that system 200 includes many other system components such as central control processor(s), display system(s), fluidic system(s), temperature control system(s), user-safety control system(s), and the like. In operation, a whole blood sample (WBS) 240 can be presented to the system 200 for analysis. In some instances, WBS 240 is aspirated into system 200. Exemplary aspiration techniques are known to the skilled artisan. After aspiration, WBS 240 can be delivered to a preparation system 210. Preparation system 210 receives WBS 240 and can perform operations involved with preparing WBS 240 for further measurement and analysis. For example, preparation system 210 may separate WBS 240 into predefined aliquots for presentation to transducer module 220. Preparation system 210 may also include mixing chambers so that appropriate reagents may be added to the aliquots. For example, where an aliquot is to be tested for differentiation of white blood cell subset populations, a lysing reagent (e.g. ERYTHROLYSE, a red blood cell lysing buffer) may be added to the aliquot to break up and remove the RBCs. Preparation system 210 may also include temperature control components to control the temperature of the reagents and/or mixing chambers. Appropriate temperature controls can improve the consistency of the operations of preparation system 210.

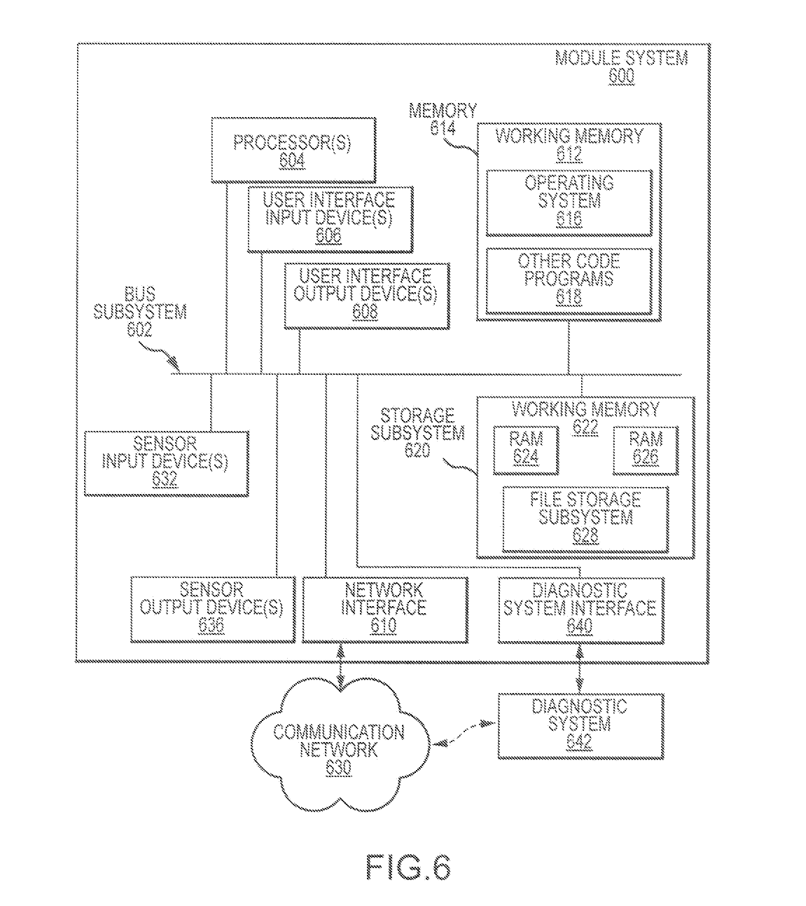

In some instances, predefined aliquots can be transferred from preparation system 210 to transducer module 220. As described in further detail below, transducer module 220 can perform direct current (DC) impedance, radiofrequency (RF) conductivity, light transmission, and/or light scatter measurements of cells from the WBS passing individually therethrough. Measured DC impedance, RF conductivity, and light propagation (e.g. light transmission, light scatter) parameters can be provided or transmitted to analysis system 230 for data processing. In some instances, analysis system 230 may include computer processing features and/or one or more modules or components such as those described herein with reference to the system depicted in FIG. 6 and described further below, which can evaluate the measured parameters, identify and enumerate the WBS constituents, and correlate a subset of data characterizing elements of the WBS with a Mycobacterium tuberculosis infection status of the individual. As shown here, cellular analysis system 200 may generate or output a report 250 containing the predicted Mycobacterium tuberculosis infection status and/or a prescribed treatment regimen for the individual. In some instances, excess biological sample from transducer module 220 can be directed to an external (or alternatively internal) waste system 260.

Tuberculosis treatment regimens may involve administration of one or more medications or antibiotics to an individual, such as isoniazid, rifampin (rifadin, rimactane), ethambutol (myambutol), pyrazinamide, fluoroquinolone, amikacin, kanamycin, capreomycin, and the like. Exemplary tuberculosis treatment regimens and therapeutics are discussed in Swindells, “New drugs to treat tuberculosis”, F1000 Med. Rep.4:12 (2012), the content of which is incorporated herein by reference. Any of these therapeutic modalities can be used for treating an individual identified as having a Mycobacterium tuberculosis infection as discussed herein.

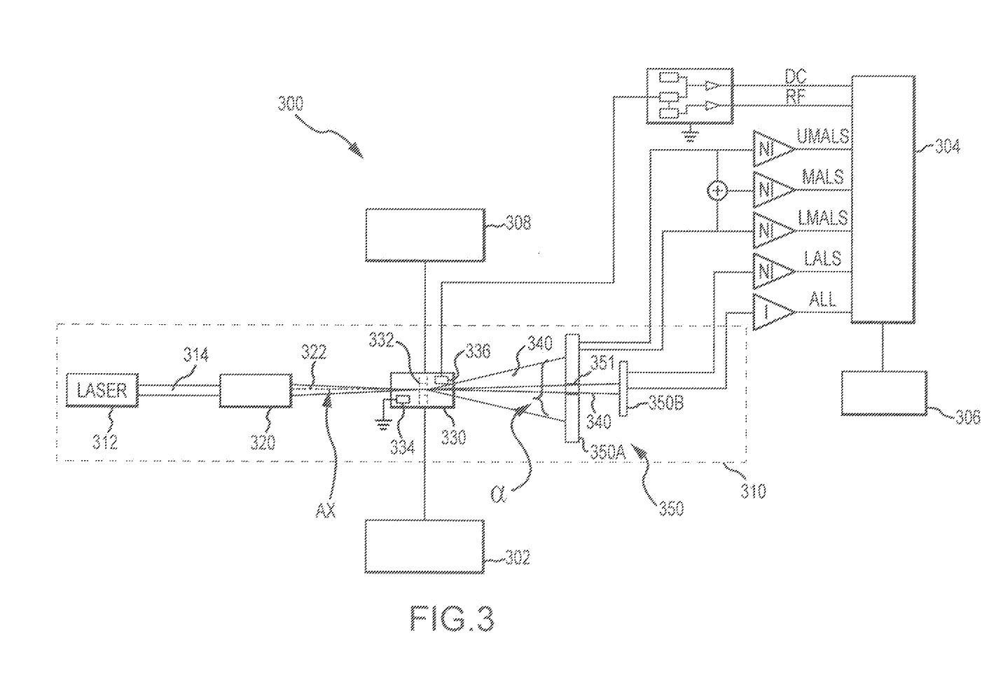

FIG. 3 illustrates in more detail a transducer module and associated components in more detail. As shown here, system 300 includes a transducer module 310 having a light or irradiation source such as a laser 310 emitting a beam 314. The laser 312 can be, for example, a 635 nm, 5 mW, solid-state laser. In some instances, system 300 may include a focus-alignment system 320 that adjusts beam 314 such that a resulting beam 322 is focused and positioned at a cell interrogation zone 332 of a flow cell 330. In some instances, flow cell 330 receives a sample aliquot from a preparation system 302. As described elsewhere herein, various fluidic mechanisms and techniques can be employed for hydrodynamic focusing of the sample aliquot within flow cell 330.

In some instances, the aliquot generally flows through the cell interrogation zone 332 such that its constituents pass through the cell interrogation zone 332 one at a time. In some cases, a system 300 may include a cell interrogation zone or other feature of a transducer module or blood analysis instrument such as those described in U.S. Pat. Nos. 5,125,737; 6,228,652; 7,390,662; 8,094,299; and 8,189,187, the contents of which are incorporated herein by references. For example, a cell interrogation zone 332 may be defined by a square transverse cross-section measuring approximately 50×50 microns, and having a length (measured in the direction of flow) of approximately 65 microns. Flow cell 330 may include an electrode assembly having first and second electrodes 334, 336 for performing DC impedance and RF conductivity measurements of the cells passing through cell interrogation zone 332. Signals from electrodes 334, 336 can be transmitted to analysis system 304. The electrode assembly can analyze volume and conductivity characteristics of the cells using low-frequency current and high-frequency current, respectively. For example, low-frequency DC impedance measurements can be used to analyze the volume of each individual cell passing through the cell interrogation zone. Relatedly, high-frequency RF current measurements can be used to determine the conductivity of cells passing through the cell interrogation zone. Because cell walls act as conductors to high frequency current, the high frequency current can be used to detect differences in the insulating properties of the cell components, as the current passes through the cell walls and through each cell interior. High frequency current can be used to characterize nuclear and granular constituents and the chemical composition of the cell interior.

Incoming beam 322 travels along beam axis AX and irradiates the cells passing through cell interrogation zone 332, resulting in light propagation within an angular range a (e.g. scatter, transmission) emanating from the zone 332. Exemplary systems are equipped with sensor assemblies that can detect light within three, four, five, or more angular ranges within the angular range a, including light associated with an extinction or axial light loss measure as described elsewhere herein. As shown here, light propagation 340 can be detected by a light detection assembly 350, optionally having a light scatter detector unit 350A and a light scatter and transmission detector unit 350B. In some instances, light scatter detector unit 350A includes a photoactive region or sensor zone for detecting and measuring upper median angle light scatter (UMALS), for example light that is scattered or otherwise propagated at angles relative to a light beam axis within a range from about 20 to about 42 degrees. In some instances, UMALS corresponds to light propagated within an angular range from between about 20 to about 43 degrees, relative to the incoming beam axis which irradiates cells flowing through the interrogation zone. Light scatter detector unit 350A may also include a photoactive region or sensor zone for detecting and measuring lower median angle light scatter (LMALS), for example light that is scattered or otherwise propagated at angles relative to a light beam axis within a range from about 10 to about 20 degrees. In some instances, LMALS corresponds to light propagated within an angular range from between about 9 to about 19 degrees, relative to the incoming beam axis which irradiates cells flowing through the interrogation zone.

A combination of UMALS and LMALS is defined as median angle light scatter (MALS), which is light scatter or propagation at angles between about 9 degrees and about 43 degrees relative to the incoming beam axis which irradiates cells flowing through the interrogation zone.

As shown in FIG. 3, the light scatter detector unit 350A may include an opening 351 that allows low angle light scatter or propagation 340 to pass beyond light scatter detector unit 350A and thereby reach and be detected by light scatter and transmission detector unit 350B. According to some embodiments, light scatter and transmission detector unit 350B may include a photoactive region or sensor zone for detecting and measuring lower angle light scatter (LALS), for example light that is scattered or propagated at angles relative to an irradiating light beam axis of about 5.1 degrees. In some instances, LALS corresponds to light propagated at an angle of less than about 9 degrees, relative to the incoming beam axis which irradiates cells flowing through the interrogation zone. In some instances, LALS corresponds to light propagated at an angle of less than about 10 degrees, relative to the incoming beam axis which irradiates cells flowing through the interrogation zone. In some instances, LALS corresponds to light propagated at an angle of about 1.9 degrees±0.5 degrees, relative to the incoming beam axis which irradiates cells flowing through the interrogation zone. In some instances, LALS corresponds to light propagated at an angle of about 3.0 degrees±0.5 degrees, relative to the incoming beam axis which irradiates cells flowing through the interrogation zone. In some instances, LALS corresponds to light propagated at an angle of about 3.7 degrees±0.5 degrees, relative to the incoming beam axis which irradiates cells flowing through the interrogation zone. In some instances, LALS corresponds to light propagated at an angle of about 5.1 degrees±0.5 degrees, relative to the incoming beam axis which irradiates cells flowing through the interrogation zone. In some instances, LALS corresponds to light propagated at an angle of about 7.0 degrees±0.5 degrees, relative to the incoming beam axis which irradiates cells flowing through the interrogation zone.

According to some embodiments, light scatter and transmission detector unit 350B may include a photoactive region or sensor zone for detecting and measuring light transmitted axially through the cells, or propagated from the irradiated cells, at an angle of 0 degrees relative to the incoming light beam axis. In some cases, the photoactive region or sensor zone may detect and measure light propagated axially from cells at angles of less than about 1 degree relative to the incoming light beam axis. In some cases, the photoactive region or sensor zone may detect and measure light propagated axially from cells at angles of less than about 0.5 degrees relative to the incoming light beam axis less. Such axially transmitted or propagated light measurements correspond to axial light loss (ALL or AL2). As noted in previously incorporated U.S. Pat. No. 7,390,662, when light interacts with a particle, some of the incident light changes direction through the scattering process (i.e. light scatter) and part of the light is absorbed by the particles. Both of these processes remove energy from the incident beam. When viewed along the incident axis of the beam, the light loss can be referred to as forward extinction or axial light loss. Additional aspects of axial light loss measurement techniques are described in U.S. Pat. No. 7,390,662 at column 5, line 58 to column 6, line 4.

As such, the cellular analysis system 300 provides means for obtaining light propagation measurements, including light scatter and/or light transmission, for light emanating from the irradiated cells of the biological sample at any of a variety of angles or within any of a variety of angular ranges, including ALL and multiple distinct light scatter or propagation angles. For example, light detection assembly 350, including appropriate circuitry and/or processing units, provides a means for detecting and measuring UMALS, LMALS, LALS, MALS, and ALL.

Wires or other transmission or connectivity mechanisms can transmit signals from the electrode assembly (e.g. electrodes 334, 336), light scatter detector unit 350A, and/or light scatter and transmission detector unit 350B to analysis system 304 for processing. For example, measured DC impedance, RF conductivity, light transmission, and/or light scatter parameters can be provided or transmitted to analysis system 304 for data processing. In some instances, analysis system 304 may include computer processing features and/or one or more modules or components such as those described herein with reference to the system depicted in FIG. 6, which can evaluate the measured parameters, identify and enumerate biological sample constituents, and correlate a subset of data characterizing elements of the biological sample with a Mycobacterium tuberculosis infection status of the individual. As shown here, cellular analysis system 300 may generate or output a report 306 containing the predicted Mycobacterium tuberculosis infection status and/or a prescribed treatment regimen for the individual. In some instances, excess biological sample from transducer module 310 can be directed to an external (or alternatively internal) waste system 308. In some instances, a cellular analysis system 300 may include one or more features of a transducer module or blood analysis instrument such as those described in previously incorporated U.S. Pat. Nos. 5,125,737; 6,228,652; 8,094,299; and 8,189,187.

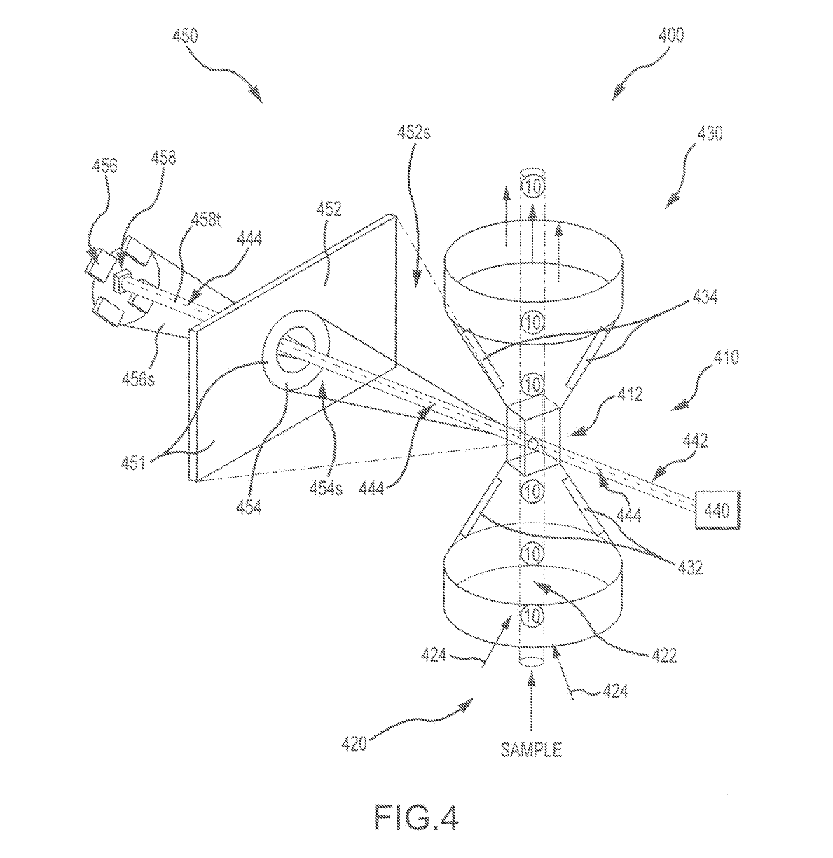

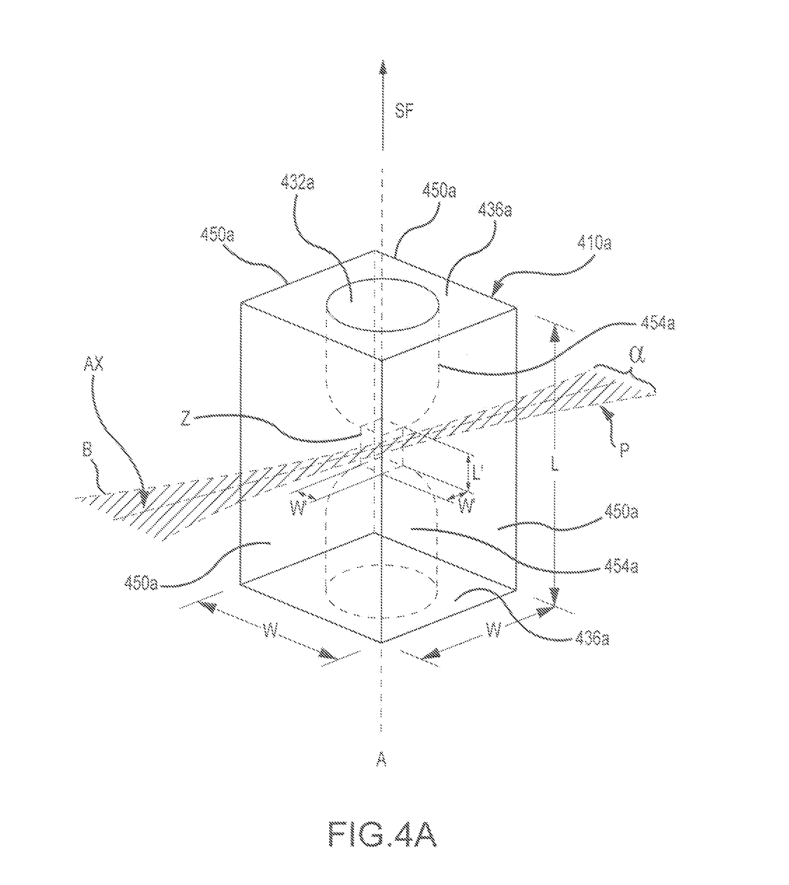

FIG. 4 illustrates aspects of an automated cellular analysis system for predicting a Mycobacterium tuberculosis infection status of an individual, according to embodiments of the present invention. In particular, the tuberculosis infection status can be predicted based on a biological sample obtained from blood of the individual. As shown here, an analysis system or transducer 400 may include an optical element 410 having a cell interrogation zone 412. The transducer also provides a flow path 420, which delivers a hydrodynamically focused stream 422 of a biological sample toward the cell interrogation zone 412. For example, as the sample stream 422 is projected toward the cell interrogation zone 412, a volume of sheath fluid 424 can also enter the optical element 410 under pressure, so as to uniformly surround the sample stream 422 and cause the sample stream 422 to flow through the center of the cell interrogation zone 412, thus achieving hydrodynamic focusing of the sample stream. In this way, individual cells of the biological sample, passing through the cell interrogation zone one cell at a time, can be precisely analyzed.

Transducer module or system 400 also includes an electrode assembly 430 that measures direct current (DC) impedance and radiofrequency (RF) conductivity of cells 10 of the biological sample passing individually through the cell interrogation zone 412. The electrode assembly 430 may include a first electrode mechanism 432 and a second electrode mechanism 434. As discussed elsewhere herein, low-frequency DC measurements can be used to analyze the volume of each individual cell passing through the cell interrogation zone. Relatedly, high-frequency RF current measurements can be used to determine the conductivity of cells passing through the cell interrogation zone. Such conductivity measurements can provide information regarding the internal cellular content of the cells. For example, high frequency RF current can be used to analyze nuclear and granular constituents, as well as the chemical composition of the cell interior, of individual cells passing through the cell interrogation zone.

The system 400 also includes a light source 440 oriented to direct a light beam 442 along a beam axis 444 to irradiate the cells 10 of the biological sample individually passing through the cell interrogation zone 412. Relatedly, the system 400 includes a light detection assembly 450 optically coupled with the cell interrogation zone, so as to measure light scattered by and transmitted through the irradiated cells 10 of the biological sample. The light detection assembly 450 can include a plurality of light sensor zones that detect and measure light propagating from the cell interrogation zone 412. In some instances, the light detection assembly detects light propagated from the cell interrogation zone at various angles or angular ranges relative to the irradiating beam axis. For example, light detection assembly 450 can detect and measure light that is scattered at various angles by the cells, as well as light that is transmitted axially by the cells along the beam axis. The light detection assembly 450 can include a first sensor zone 452 that measures a first scattered or propagated light 452s within a first range of angles relative to the light beam axis 444. The light detection assembly 450 can also include a second sensor zone 454 that measures a second scattered or propagated light 454s within a second range of angles relative to the light beam axis 444. As shown here, the second range of angles for scattered or propagated light 454s is different from the first range of angles for scattered or propagated light 452s. Further, the light detection assembly 450 can include a third sensor zone 456 that measures a third scattered or propagated light 456s within a third range of angles relative to the light beam axis 444. As shown here, the third range of angles for scattered or propagated light 456s is different from both the first range of angles for scattered or propagated light 452s and the second range of angles for scattered or propagated light 454s. The light detection assembly 450 also includes a fourth sensor zone 458 that measures axial light 458t transmitted through the cells of the biological sample passing individually through the cell interrogation zone 412 or propagated from the cell interrogation zone along the axis beam. In some instances, each of the sensor zones 452, 454, 456, and 458 are disposed at a separate sensor associated with that specific sensor zone. In some instances, one or more of the sensor zones 452, 454, 456, and 458 are disposed on a common sensor of the light detection assembly 450. For example, the light detection assembly may include a first sensor 451 that includes first sensor zone 452 and second sensor zone 454. Hence, a single sensor may be used for detecting or measuring two or more types (e.g. low angle, medium angle, or high angle) of light scatter or propagation.

Automated cellular analysis systems may include any of a variety of optical elements or transducer features. For example, as depicted in FIG. 4A, an optical element 410a of a cellular analysis system transducer may have a square prism shape, with four rectangular, optically flat sides 450a and opposing end walls 436a. In some instances, the respective widths W of each side 450a are the same, each measuring about 4.2 mm, for example. In some instances, the respective lengths L of each side 450a are the same, each measuring about 6.3 mm, for example. In some instances, all or part of the optical element 410a may be fabricated from fused silica, or quartz. A flow passageway 432a formed through a central region of optical element 410a may be concentrically configured with respect to a longitudinal axis A passing through the center of element 410a and parallel to a direction of sample-flow as indicated by arrow SF. Flow passageway 432a includes a cell interrogation zone Z and a pair of opposing tapered bore holes 454a having openings in the vicinity of their respective bases that fluidically communicate with the cell interrogation zone. In some instances, the transverse cross-section of the cell interrogation zone Z is square in shape, the width W′ of each side nominally measuring 50 microns±10 microns. In some instances, the length L′ of the cell interrogation zone Z, measured along axis A, is about 1.2 to 1.4 times the width W′ of the interrogation zone. For example, the length L′ may be about 65 microns±10 microns. As noted elsewhere herein, DC and RF measurements can be made on cells passing through the cell interrogation zone. In some instances, the maximum diameter of the tapered bore holes 454a, measured at end walls 436a, is about 1.2 mm. An optical structure 410a of the type described can be made from a quartz square rod containing a 50×50 micron capillary opening, machined to define the communicating bore holes 454a, for example. A laser or other irradiation source can produce a beam B that is directed through or focused into the cell interrogation zone. For example, the beam may be focused into an elliptically shaped waist located within the interrogation zone Z at a location through which the cells are caused to pass. A cellular analysis system may include a light detection assembly that is configured to detect light which emanates from the optical element 410a, for example light P that is propagated from the cell interrogation zone Z which contains illuminated or irradiated cells flowing therewithin. As depicted here, light P can propagate or emanate from the cell interrogation zone Z within an angular range a, and thus can be measured or detected at selected angular positions or angular ranges relative to the beam axis AX. Relatedly, a light detection assembly can detect light scattered or axially transmitted in a forward plane within various angular ranges with respect to an axis AX of beam B. As discussed elsewhere herein, one or more light propagation measurements can be obtained for individual cells passing through the cell interrogation zone one at a time. In some cases, a cellular analysis system may include one or more features of a transducer or cell interrogation zone such as those described in U.S. Pat. Nos. 5,125,737; 6,228,652; 8,094,299; and 8,189,187, the contents of which are incorporated herein by reference.

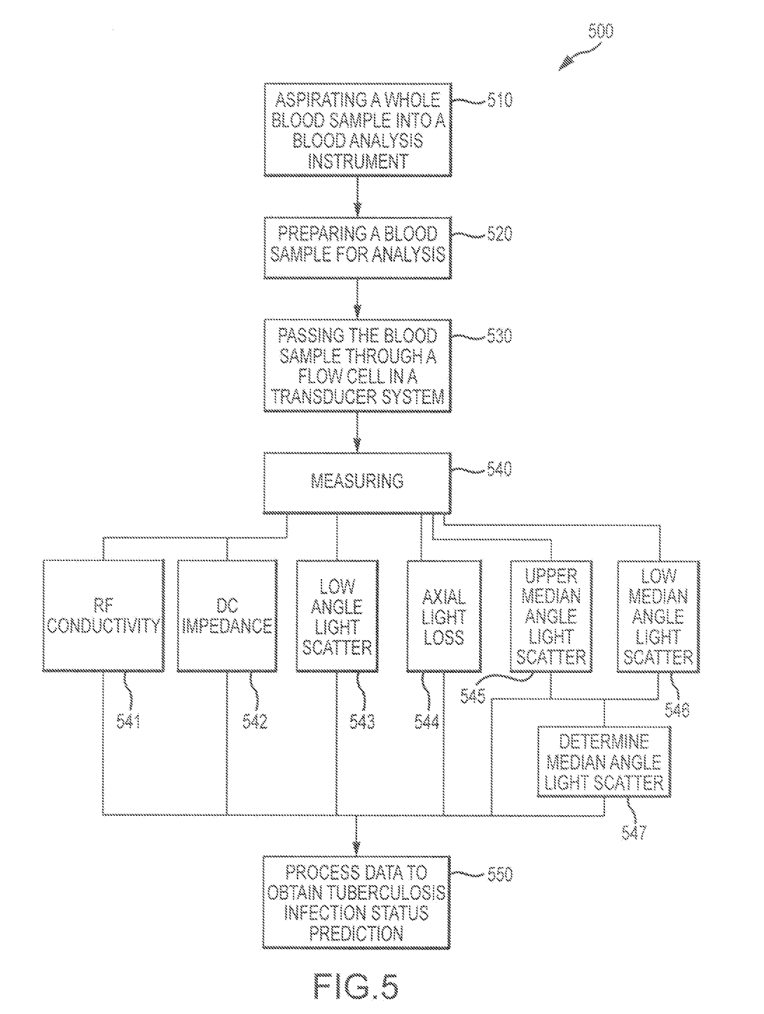

FIG. 5 depicts aspects of an exemplary method 500 for predicting a Mycobacterium tuberculosis infection status of an individual. Method 500 includes introducing a blood sample into a blood analysis system, as indicated by step 510. As shown in step 520, the method may also include preparing the blood sample by dividing the sample into aliquots and mixing the aliquot samples with appropriate reagents. In step 530, the samples can be passed through a flow cell in a transducer system such that sample constituents (e.g. blood cells) pass through a cell interrogation zone in a one by one fashion. The constituents can be irradiated by a light source, such as a laser. In step 540, any combination RF conductivity 541, DC impedance 542, first angular light propagation 543 (e.g. LALS), second angular light propagation 544 (e.g. AL2), third angular light propagation 545 (e.g. UMAL), and/or fourth angular light propagation 546 (e.g. LMALS) may be measured. As depicted by step 547, the third and fourth angular light propagation measurements can be used to determine a fifth angular light propagation measurement (e.g. MALS). Alternatively, MALS can be measured directly. As discussed elsewhere herein, certain measurements or combinations of measurements can be processed, as indicated by step 550, so as to provide a Mycobacterium tuberculosis infection status prediction. Optionally, methods may also include determining a treatment regime based on the predicted Mycobacterium tuberculosis infection status.

A cellular analysis system may be configured to correlate a subset of DC impedance, RF conductivity, angular light measurements (e.g. first scattered light, second scattered light) and the axial light measurements from the cells of the biological sample with a Mycobacterium tuberculosis infection status of an individual. As discussed elsewhere herein, in some instances at least a portion of the correlation can be performed using one or more software modules executable by one or more processors, one or more hardware modules, or any combination thereof. Processors or other computer or module systems may be configured to receive as an input values for the various measurements or parameters and automatically output the predicted Mycobacterium tuberculosis infection status of the individual. In some instances, one or more of the software modules, processors, and/or hardware modules may be included as a component of a hematology system that is equipped to obtain multiple light angle detection parameters, such as Beckman Coulter's UniCel® DxHT™ 800 Cellular Analysis System. In some instances, one or more of the software modules, processors, and/or hardware modules may be included as a component of a stand-alone computer that is in operative communication or connectivity with a hematology system that is equipped to obtain multiple light angle detection parameters, such as Beckman Coulter's UniCel® DxH 800 System. In some instances, at least a portion of the correlation can be performed by one or more of the software modules, processors, and/or hardware modules that receive data from a hematology system that is equipped to obtain multiple light angle detection parameters, such as Beckman Coulter's UniCel® DxH 800 System remotely via the internet or any other over wired and/or wireless communication network. Relatedly, each of the devices or modules according to embodiments of the present invention can include one or more software modules on a computer readable medium that is processed by a processor, or hardware modules, or any combination thereof.

FIG. 6 is a simplified block diagram of an exemplary module system that broadly illustrates how individual system elements for a module system 600 may be implemented in a separated or more integrated manner. Module system 600 may be part of or in connectivity with a cellular analysis system for predicting a Mycobacterium tuberculosis infection status of an individual according to embodiments of the present invention. Module system 600 is well suited for producing data or receiving input related to a tuberculosis analysis. In some instances, module system 600 includes hardware elements that are electrically coupled via a bus subsystem 602, including one or more processors 604, one or more input devices 606 such as user interface input devices, and/or one or more output devices 608 such as user interface output devices. In some instances, system 600 includes a network interface 610, and/or a diagnostic system interface 640 that can receive signals from and/or transmit signals to a diagnostic system 642. In some instances, system 600 includes software elements, for example shown here as being currently located within a working memory 612 of a memory 614, an operating system 616, and/or other code 618, such as a program configured to implement one or more aspects of the techniques disclosed herein.

In some embodiments, module system 600 may include a storage subsystem 620 that can store the basic programming and data constructs that provide the functionality of the various techniques disclosed herein. For example, software modules implementing the functionality of method aspects, as described herein, may be stored in storage subsystem 620. These software modules may be executed by the one or more processors 604. In a distributed environment, the software modules may be stored on a plurality of computer systems and executed by processors of the plurality of computer systems. Storage subsystem 620 can include memory subsystem 622 and file storage subsystem 628. Memory subsystem 622 may include a number of memories including a main random access memory (RAM) 626 for storage of instructions and data during program execution and a read only memory (ROM) 624 in which fixed instructions are stored. File storage subsystem 628 can provide persistent (non-volatile) storage for program and data files, and may include tangible storage media which may optionally embody patient, treatment, assessment, or other data. File storage subsystem 628 may include a hard disk drive, a floppy disk drive along with associated removable media, a Compact Digital Read Only Memory (CD-ROM) drive, an optical drive, DVD, CD-R, CD RW, solid-state removable memory, other removable media cartridges or disks, and the like. One or more of the drives may be located at remote locations on other connected computers at other sites coupled to module system 600. In some instances, systems may include a computer-readable storage medium or other tangible storage medium that stores one or more sequences of instructions which, when executed by one or more processors, can cause the one or more processors to perform any aspect of the techniques or methods disclosed herein. One or more modules implementing the functionality of the techniques disclosed herein may be stored by file storage subsystem 628. In some embodiments, the software or code will provide protocol to allow the module system 600 to communicate with communication network 630. Optionally, such communications may include dial-up or internet connection communications.

It is appreciated that system 600 can be configured to carry out various aspects of methods of the present invention. For example, processor component or module 604 can be a microprocessor control module configured to receive cellular parameter signals from a sensor input device or module 632, from a user interface input device or module 606, and/or from a diagnostic system 642, optionally via a diagnostic system interface 640 and/or a network interface 610 and a communication network 630. In some instances, sensor input device(s) may include or be part of a cellular analysis system that is equipped to obtain multiple light angle detection parameters, such as Beckman Coulter's UniCel® DxH™ 800 Cellular Analysis System. In some instances, user interface input device(s) 606 and/or network interface 610 may be configured to receive cellular parameter signals generated by a cellular analysis system that is equipped to obtain multiple light angle detection parameters, such as Beckman Coulter's UniCel® DxH™ 800 Cellular Analysis System. In some instances, diagnostic system 642 may include or be part of a cellular analysis system that is equipped to obtain multiple light angle detection parameters, such as Beckman Coulter's UniCel® DxH™ 800 Cellular Analysis System.

Processor component or module 604 can also be configured to transmit cellular parameter signals, optionally processed according to any of the techniques disclosed herein, to sensor output device or module 636, to user interface output device or module 608, to network interface device or module 610, to diagnostic system interface 640, or any combination thereof. Each of the devices or modules according to embodiments of the present invention can include one or more software modules on a computer readable medium that is processed by a processor, or hardware modules, or any combination thereof. Any of a variety of commonly used platforms, such as Windows, MacIntosh, and Unix, along with any of a variety of commonly used programming languages, may be used to implement embodiments of the present invention.

User interface input devices 606 may include, for example, a touchpad, a keyboard, pointing devices such as a mouse, a trackball, a graphics tablet, a scanner, a joystick, a touchscreen incorporated into a display, audio input devices such as voice recognition systems, microphones, and other types of input devices. User input devices 606 may also download a computer executable code from a tangible storage media or from communication network 630, the code embodying any of the methods or aspects thereof disclosed herein. It will be appreciated that terminal software may be updated from time to time and downloaded to the terminal as appropriate. In general, use of the term “input device” is intended to include a variety of conventional and proprietary devices and ways to input information into module system 600.

User interface output devices 606 may include, for example, a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide a non-visual display such as via audio output devices. In general, use of the term “output device” is intended to include a variety of conventional and proprietary devices and ways to output information from module system 600 to a user.

Bus subsystem 602 provides a mechanism for letting the various components and subsystems of module system 600 communicate with each other as intended or desired. The various subsystems and components of module system 600 need not be at the same physical location but may be distributed at various locations within a distributed network. Although bus subsystem 602 is shown schematically as a single bus, alternate embodiments of the bus subsystem may utilize multiple busses.

Network interface 610 can provide an interface to an outside network 630 or other devices. Outside communication network 630 can be configured to effect communications as needed or desired with other parties. It can thus receive an electronic packet from module system 600 and transmit any information as needed or desired back to module system 600. As depicted here, communication network 630 and/or diagnostic system interface 642 may transmit information to or receive information from a diagnostic system 642 that is equipped to obtain multiple light angle detection parameters, such as such as Beckman Coulter's UniCel® DxH™ 800 Cellular Analysis System.

In addition to providing such infrastructure communications links internal to the system, the communications network system 630 may also provide a connection to other networks such as the internet and may comprise a wired, wireless, modem, and/or other type of interfacing connection.

It will be apparent to the skilled artisan that substantial variations may be used in accordance with specific requirements. For example, customized hardware might also be used and/or particular elements might be implemented in hardware, software (including portable software, such as applets), or both. Further, connection to other computing devices such as network input/output devices may be employed. Module terminal system 600 itself can be of varying types including a computer terminal, a personal computer, a portable computer, a workstation, a network computer, or any other data processing system. Due to the ever-changing nature of computers and networks, the description of module system 600 depicted in FIG. 6 is intended only as a specific example for purposes of illustrating one or more embodiments of the present invention. Many other configurations of module system 600 are possible having more or less components than the module system depicted in FIG. 6. Any of the modules or components of module system 600, or any combinations of such modules or components, can be coupled with, or integrated into, or otherwise configured to be in connectivity with, any of the cellular analysis system embodiments disclosed herein. Relatedly, any of the hardware and software components discussed above can be integrated with or configured to interface with other medical assessment or treatment systems used at other locations.

In some embodiments, the module system 600 can be configured to receive one or more cellular analysis parameters of a patient at an input module. Cellular analysis parameter data can be transmitted to an assessment module where a Mycobacterium tuberculosis infection status is predicted or determined. The predicted tuberculosis infection status can be output to a system user via an output module. In some cases, the module system 600 can determine an initial treatment or induction protocol for the patient, based on one or more cellular analysis parameters and/or the predicted Mycobacterium tuberculosis infection status, for example by using a treatment module. The treatment can be output to a system user via an output module. Optionally, certain aspects of the treatment can be determined by an output device, and transmitted to a treatment system or a sub-device of a treatment system. Any of a variety of data related to the patient can be input into the module system, including age, weight, sex, treatment history, medical history, and the like. Parameters of treatment regimens or diagnostic evaluations can be determined based on such data.

Relatedly, in some instances a system includes a processor configured to receive the cell population data as input. Optionally, a processor, storage medium, or both, may be incorporated within a hematology or cellular analysis machine. In some instances, the hematology machine may generate cell population data or other information for input into the processor. In some instances, a processor, a storage medium, or both, can be incorporated within a computer, and the computer can be in communication with a hematology machine. In some instances, a processor, a storage medium, or both, can be incorporated within a computer, and the computer can be in remote communication with a hematology machine via a network.

According to some embodiments, a hematology machine can generate cell population data using any of the features disclosed herein.

Cell Population Data

In addition to a differential count, once the WBC sub-populations are formed, the mean (MN) and standard deviation (SD) values for the grades of various morphologic parameters (e.g. volume, conductivity, and angles of light scatter or propagation) can be calculated separately for leukocytes and other blood cells. For example, a WBC differential channel can provide measurement data for neutrophils, lymphocytes, monocytes, and eosinophils, and an nRBC channel can provide measurement data for non-nucleated red blood cells or a non-nucleated red blood cell parameter, as described elsewhere herein. As a result, a vast amount of data directly correlating to blood cell morphology can be generated. This information can be called collectively “Cell Population Data” (CPD). Table 1 depicts a variety of Cell Population Data parameters which may be obtained based on a biological sample of an individual.

TABLE 1

| | | | | | Non-nucleated |
|---|---|---|---|---|---|
| | | | Monocyte | | red blood cell |
| | Neutrophil | Lymphocyte | MO (mo or | Eosinophil | NNRBC (nnr or |
| | NE (ne) | LY (ly) | mn) | EO (eo) | nnrbc) |
| Cell | SD-C-NE | SD-C-LY | SD-C-MO | SD-C-EO | SD-C-NNRBC |
| Conductivity | MN-C-NE | MN-C-LY | MN-C-MO | MN-C-EO | MN-C-NNRBC |
| (C) | | | | | |
| high freq. | | | | | |
| current | | | | | |
| Cell Volume | SD-V-NE | SD-V-LY | SD-V-MO | SD-V-EO | SD-V-NNRBC |
| (V) | MN- V-NE | MN-V-LY | MN-V-MO | MN-V-EO | MN-V-NNRBC |
| low freq. | | | | | |
| current | | | | | |
| Axial light | SD-AL2-NE | SD-AL2-LY | SD-AL2- | SD-AL2-EO | SD-AL2-NNRBC |
| loss or | MN-AL2- | MN-AL2-LY | MO | MN-AL2- | MN-AL2- |
| absorbed | NE | | MN-AL2- | EO | NNRBC |
| light (AL2 or | | | MO | | |
| ALL) | | | | | |
| Low-angle | SD-LALS- | SD-LALS- | SD-LALS- | SD-LALS- | SD-LALS- |
| light scatter | NE | LY | MO | EO | NNRBC |
| (LALS) | MN-LALS- | MN-LALS- | MN-LALS- | MN-LALS- | MN-LALS- |
| | NE | LY | MO | EO | NNRBC |
| Upper | SD- | SD-UMALS- | SD- | SD- | SD-UMALS- |
| median-angle | UMALS-NE | LY | UMALS- | UMALS-EO | NNRBC |
| light scatter | MN- | MN- | MO | MN- | MN-UMALS- |
| (UMALS) | UMALS-NE | UMALS-LY | MN- | UMALS-EO | NNRBC |
| | | | UMALS- | | |
| | | | MO | | |
| Lower | SD-LMALS- | SD-LMALS- | SD-LMALS- | SD-LMALS- | SD-LMALS- |
| median-angle | NE | LY | MO | EO | NNRBC |
| light scatter | MN- | MN- | MN- | MN- | MN-LMALS- |
| (LMALS) | LMALS-NE | LMALS-LY | LMALS-MO | LMALS-EO | NNRBC |
| Median- | SD-MALS- | SD-MALS- | SD-MALS- | SD-MALS- | SD-MALS- |
| angle light | NE | LY | MO | EO | NNRBC |
| scatter | MN-MALS- | MN-MALS- | MN-MALS- | MN-MALS- | MN-MALS- |
| (MALS) | NE | LY | MO | EO | NNRBC |
| [UMALS + | | | | | |
| LMALS] | | | | | |

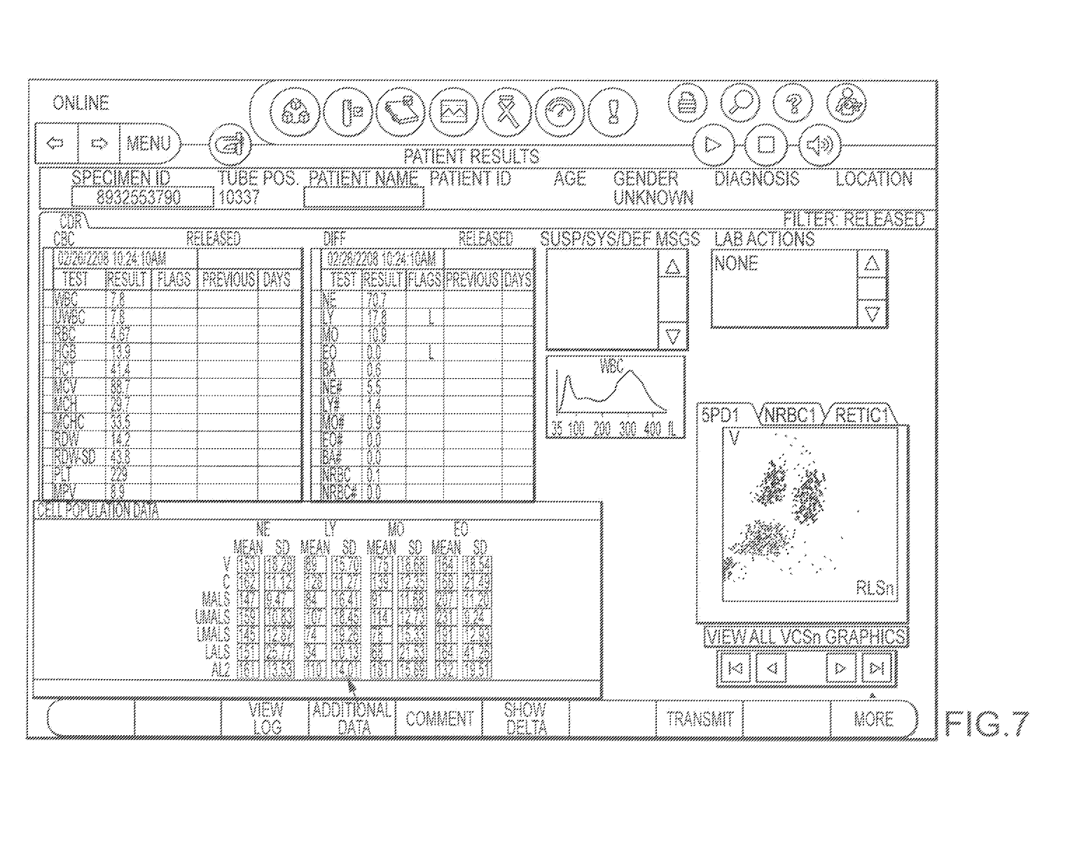

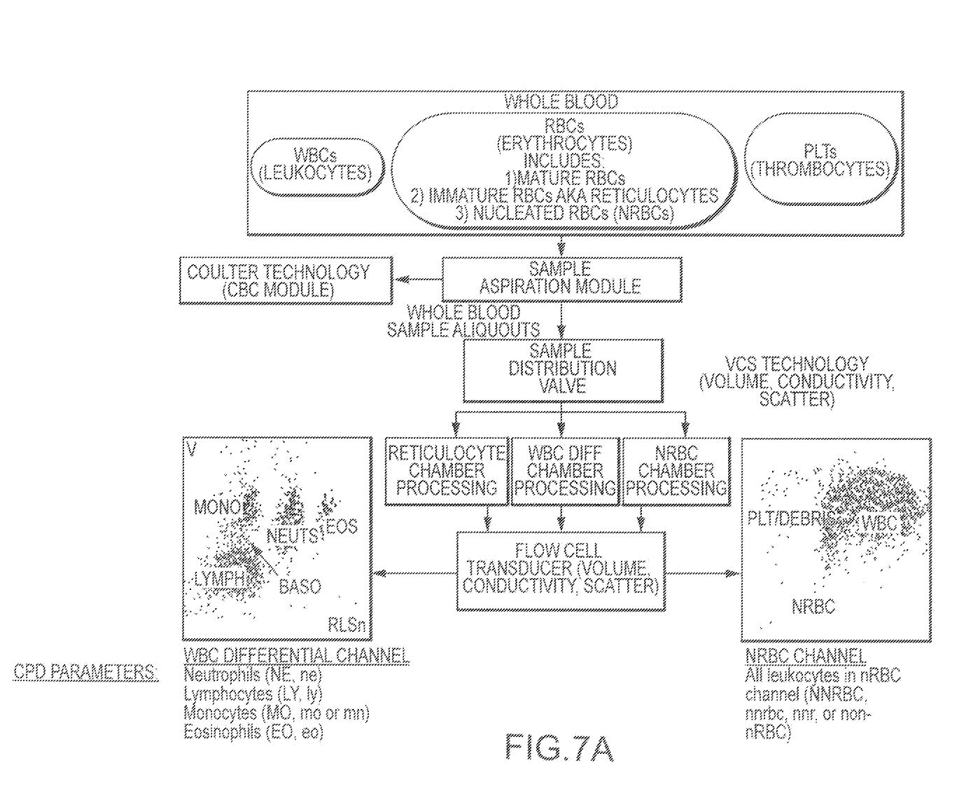

CPD values can be viewed on the screen of an instrument, such as that depicted in FIG. 7, as well as automatically exported as an Excel file. Hence, white blood cells (WBC's) can be analyzed and individually plotted in tri-dimensional histograms, with the position of each cell on the histogram being defined by certain parameters as described herein. In some instances, systems or methods can grade the cell in a range from 1 to 256 points, for each of the parameters.

Because WBCs of the same sub-type, for example granulocytes (or neutrophils), lymphocytes, monocytes, eosinophils, and basophils, often have similar morphologic features, they may tend to be plotted in similar regions of the tri-dimensional histogram, thus forming cell populations. The number of events in each population can be used to generate a differential count. FIG. 7 depicts an exemplary screen shot of a differential count screen. As illustrated here, the WBC sub-populations are in clearly separated groups at different locations on the histogram, and are defined by different colors. The histogram shown here provides cell size (volume) in the y axis and light scatter in the x axis.

By clicking on the “Additional Data” tab, users can view the CPD values. Such CPD values can correspond to the position of the population in the histogram, and to the morphology of the WBCs under the microscope. For example, monocytes are known to be the largest of all WBCs, and have the highest mean volume. Lymphocytes are known to be the smallest of all WBCs, and have the lowest mean volume. Lymphocytes also have the lowest level of cytoplasmic granularity and the least complex nuclear morphology, and have the lowest mean light scatter, called MALS. As depicted in FIG. 7A, the WBC differential channel can provide measurement data for neutrophils, lymphocytes, monocytes, and eosinophils. The nRBC channel can provide measurement data for non-nucleated red blood cells (nnRBC). As discussed herein, the term nnRBC can refer to all leukocytes in the nRBC channel. In the nRBC chamber, a portion of a whole blood sample can be diluted and treated with a lysing reagent that selectively removes non-nucleated red blood cells, and that maintains the integrity of nucleated red blood cells (nRBCs), white blood cells (WBCs), and any platelets or cellular debris that may be present.

CPD parameters can be used to analyze cellular morphology in a quantitative, objective, and automated manner, free from the subjectivity of human interpretation, which is also very time consuming, expensive, and has limited reproducibility. CPD parameters can be used for improving the value of the CBC-diff in the diagnosis of various medical conditions that alter the morphology of WBCs. According to some embodiment, cell population data can be obtained using any of the features disclosed herein.

As further discussed herein, it has been discovered that certain CPD parameter values or value ranges are highly useful for predicting a Mycobacterium tuberculosis infection status in an individual. Accordingly, these parameter values or value ranges can be implemented in systems and methods for the diagnosis of Mycobacterium tuberculosis infection.

Calculated Parameters

Table 2 depicts a variety of calculated parameters which may be obtained based on a biological sample of an individual. According to some embodiments, a calculated parameter can refer to a relation or ratio between two CPD parameters. For example, the calculated parameter ne-umals/al2 refers to the ratio of UMALS to AL2 for neutrophils.

TABLE 2

| | | | | | Non-nucleated |
|---|---|---|---|---|---|
| | | | Monocyte | | red blood cell |
| | Neutrophil | Lymphocyte | MO (mo or | Eosinophil | NNRBC (nnr or |
| | NE (ne) | LY (ly) | mn) | EO (eo) | nnrbc) |
| umals/al2 | ne umals/al2 | ly umals/al2 | mn umals/al2 | eo umals/al2 | nnrbc umals/al2 |
| mals/al2 | ne mals/al2 | ly mals/al2 | mn mals/al2 | eo mals/al2 | nnrbc mals/al2 |
| lmals/al2 | ne lmals/al2 | ly lmals/al2 | mn lmals/al2 | eo lmals/al2 | nnrbc lmals/al2 |
| lals/al2 | ne lals/al2 | ly lals/al2 | mn mn | eo lals/al2 | nnrbc lals/al2 |
| | | | lals/al2 | | |
| umals/v | ne umals/v | ly umals/v | mn mn | eo umals/v | nnrbc umals/v |
| | | | umals/v | | |
| mals/v | ne mals/v | ly mals/v | mn mals/v | eo mals/v | nnrbc mals/v |
| lmals/v | ne lmals/v | ly lmals/v | mn lmals/v | eo lmals/v | nnrbc lmals/v |
| lals/v | ne lals/v | ly lals/v | mn mn lals/v | eo lals/v | nnrbc lals/v |
| v/al2 | ne v/al2 | ly v/al2 | mn mn v/al2 | eo v/al2 | nnrbc v/al2 |
| c/al2 | ne c/al2 | ly c/al2 | mn c/al2 | eo c/al2 | nnrbc c/al2 |
| c/v | ne c/v | ly c/v | mn c/v | eo c/v | nnrbc c/v |
| umals/mals | ne | ly umals/mals | mn | eo | nnrbc |
| | umals/mals | | umals/mals | umals/mals | umals/mals |
| lmals/mals | ne | ly lmal/mals | mn | eo | nnrbc lmals/mals |
| | lmals/mals | | lmals/mals | lmals/mals | |
| lals/mals | ne lals/mals | ly lals/mals | mn lals/mals | eo lals/mals | nnrbc lals/mals |

It has been discovered that particular values or value ranges of certain calculated parameters are highly useful for predicting a Mycobacterium tuberculosis infection status of an individual. Accordingly, these calculated parameter values or ranges can be implemented in systems and methods for the diagnosis of Mycobacterium tuberculosis infections.

Decision Rules

Embodiments of the present invention encompass multiparametric techniques based on CPD and calculated parameters that can reliably predict the presence of Mycobacterium tuberculosis infection in an individual. Such predictions can be used when developing a treatment or therapy regimen. In some cases, such treatments or therapies can be determined before other diagnostics results (e.g. culturing) are available. By providing early and accurate predictions of a tuberculosis infection status in an individual, there is an improved prognosis for the patient.

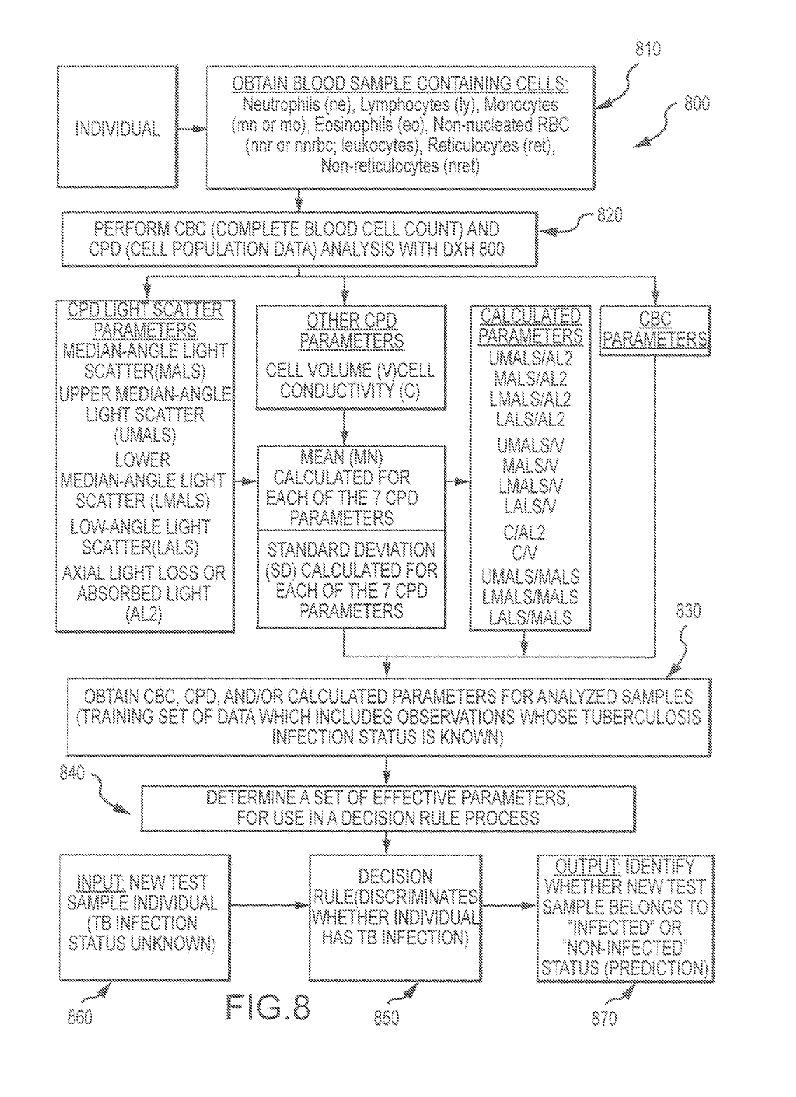

FIG. 8 schematically illustrates a method 800 for obtaining and using a decision rule according to embodiments of the present invention. As depicted here, the method includes obtaining blood samples from individuals (e.g. during routine examinations), as indicated by step 810. Complete blood count (CBC) and/or CPD data can be obtained from these biological samples, using a cellular analysis system that is equipped to obtain multiple light angle detection parameters, such as Beckman Coulter's UniCel® DxH 800 System, as indicated by step 820. CBC, CPD, and/or calculated parameters from analyzed samples can be used to build a training set of data, which includes observations whose tuberculosis infection status is known, as shown by step 830. The method also includes determining a set of effective parameters based on the training set of data, for use in a decision rule process, as indicated by step 840. As shown here, a decision rule 850, which is based on the set of effective parameters, can be used to analyze a new unknown test sample 860 of an individual, in order to predict a tuberculosis infection status 870 of the individual.

Analysis System Programmed With Decision Rules

Embodiments of the present invention encompass cellular analysis systems and other automated biological investigation devices which are programmed to carry out tuberculosis infection status prediction or identification methods according to decision rules as disclosed herein. For example, a systems that is equipped to obtain and/or process multiple light angle detection parameters, such as Beckman Coulter's UniCel® DxH 800 System, or processors or other computer or module systems associated therewith or incorporated therein, can be configured based on decision rules described herein to receive as input values for the various measurements or parameters discussed herein, and automatically output a predicted Mycobacterium tuberculosis infection status. The predicted status may provide an indication that the individual is infected, or is not infected, with tuberculosis. In some instances, a system that is equipped to obtain and/or process multiple light angle detection parameters, such as a Beckman Coulter UniCel® DxH 800 System, may include a processor or storage medium that is configured to automatically implement a tuberculosis decision rule, whereby data obtained from a biological sample analyzed by a system that is equipped to obtain multiple light angle detection parameters, such as the DxH 800 System, is also processed by a system that is equipped to obtain and/or process multiple light angle detection parameters, such as the DxH 800 System, and a tuberculosis prediction or indication is provided or output by the system that is equipped to obtain and/or process multiple light angle detection parameters, such as the DxH 800 System, based on the analyzed data.

CPD data can be obtained from individuals from the general population and input into a spreadsheet (Excel). With this data, a data analysis technique can be used to compare groups of tuberculosis cases and generate combinations of CPD based rules that can best predict whether or not an individual has a Mycobacterium tuberculosis infection. In some instances, calculated parameters (e.g. ratios between various CPD parameters) can be used, which allows for the presence of automatic internal controls for possible variations that may be inherent to the instrument, such as dilution variability, voltage changes, the exact positioning of the laser beam, and several other factors that may affect the instrument reading, but in doing so results are affected equally across WBC sub-types.

The data analysis technique can be performed using a multistep strategy. Briefly, effective parameters can be selected for screening at desired sensitivity and/or specificity values. Certain values or value ranges for these effective parameters can be determined which result in the decision rules. The sensitivity and specificity for the decision rules can be calculated. The combination and range of CPD and calculated parameters that can discriminate tuberculosis infections (e.g. from other diseases and normal controls) can be determined using an Excel macroprogram.

In a first step, characteristic CBC, CPD, and calculated parameter patterns of tuberculosis cases can be identified. A multiparametric model can be developed that can predict whether an unknown case would be positive for tuberculosis. The sensitivity and the specificity of the model can be evaluated. In this first step, cases can be categorized as being either tuberculosis or non-tuberculosis.

For this step, case set A (“test set”) can be used to identify the characteristic CBC, CPD, and calculated parameter patterns of tuberculosis cases and to develop a multiparametric model for discriminating such cases. Once the model is developed, it can be applied blindly to case set B (“validation set”), to calculate the sensitivity and specificity of the model in an unknown and totally different set of cases, thus simulating the performance such models would have in a real life scenario being used in a routine hematology laboratory.

Using case set A, certain complete blood cell count, cell population data, and calculated parameters can be identified for incorporation into a prediction model or decision rule for identifying cases of tuberculosis in a general population.

For the “test set”, this multi-parameter model can correctly identify a certain percentage of tuberculosis cases (e.g. sensitivity), and correctly rule out tuberculosis in other cases (e.g. specificity). It has been discovered that certain CBC parameter values or value ranges, certain CPD parameter values or value ranges, and certain calculated parameter values of value ranges, when taken in combination, are highly useful for predicting a tuberculosis infection status in an individual.

In some instances, particular values and ranges may be associated with a specific hematology analyzer used to analyze the biological sample, and calibrations may vary from device to device, even among the same brand and model of device.

After developing the above mentioned tuberculosis model, it can be applied to a totally different set of cases (set B). The performance of this model can be evaluated in terms of sensitivity and specificity.

As demonstrated by such studies, the systems and methods disclosed herein provide robust modalities for accurately predicting a tuberculosis infection in an individual within a larger population, using data that was obtained during a CBC-differential performed by the hematology analyzer DxH 800. The models can be used to correctly classify cases of tuberculosis in both the test and the validation study sets. Hence, embodiments of the present invention provide techniques for quickly identifying individuals having tuberculosis, and treatment can be started without having to wait for results from other time consuming tests, thus providing the patient with a reduced risk of an adverse outcome. For these reasons, knowing that the use of decision rule models allow for a morphologic analysis which correctly identifies tuberculosis with favorable sensitivity and specificity certainly can be very reassuring for medical professionals and patients alike.

### EXAMPLE

### A. Materials and Methods

1. Data Collection and Group Assignment.

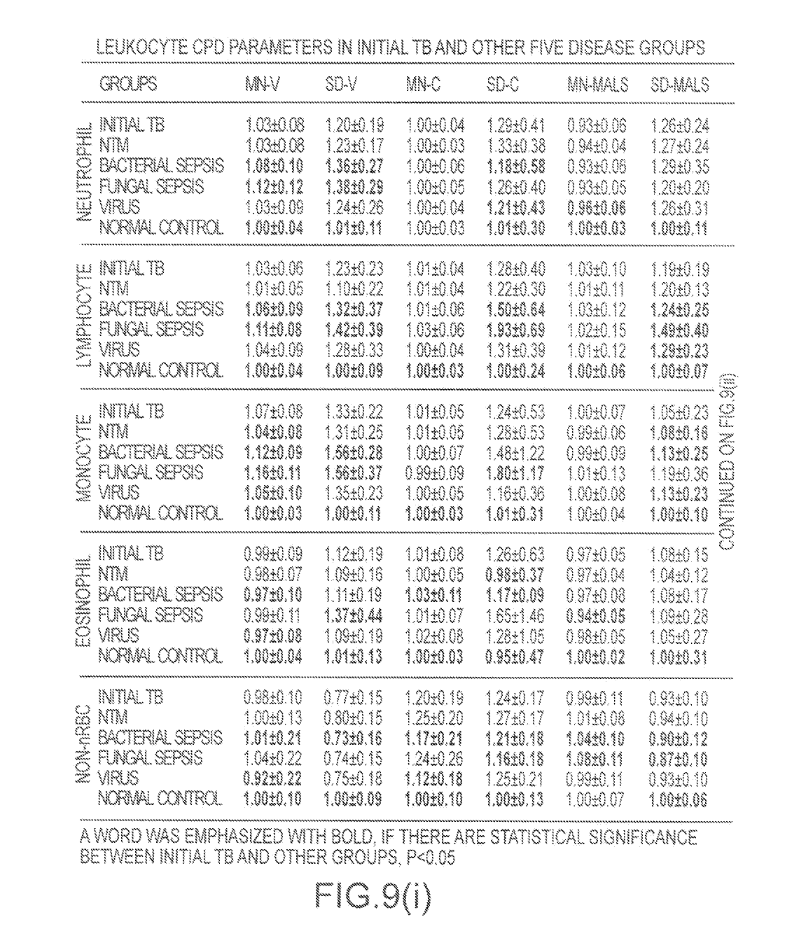

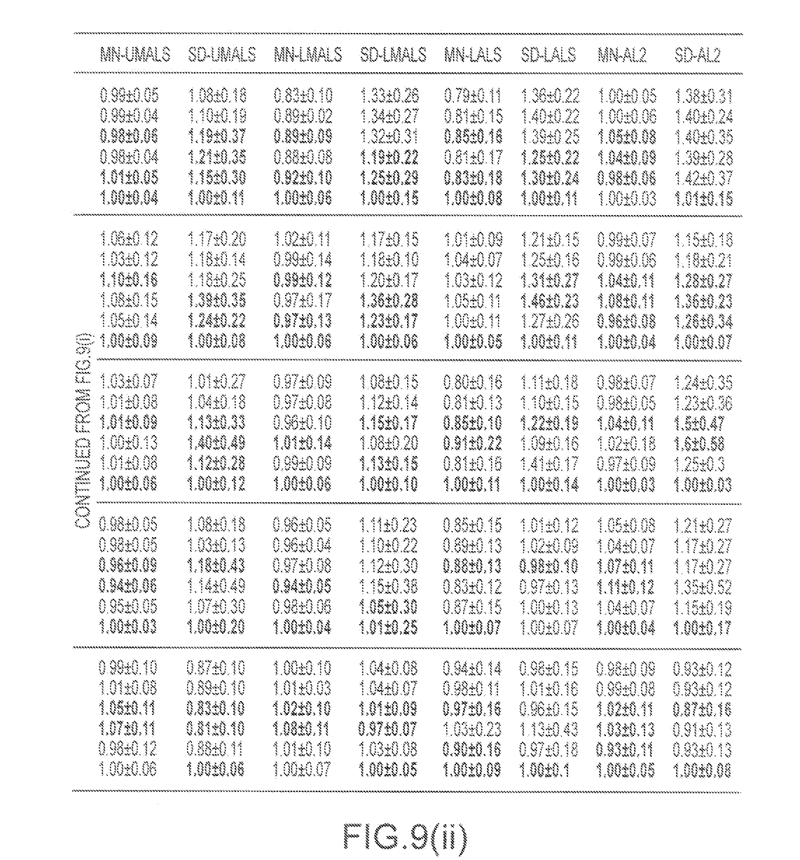

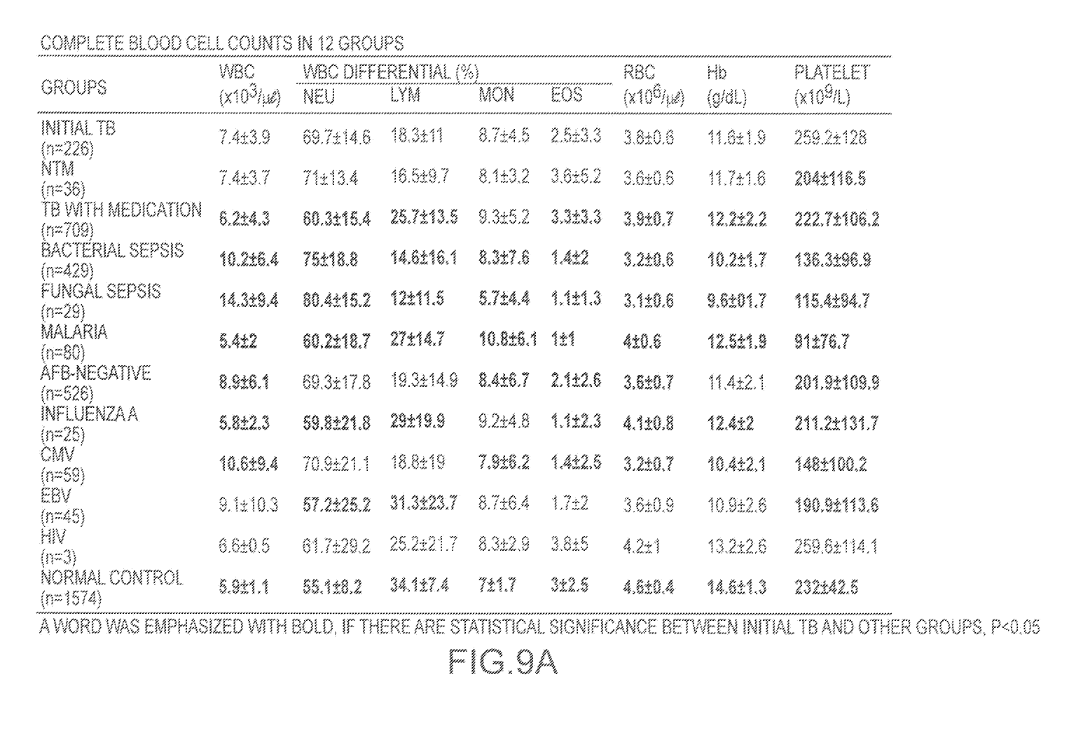

A total of 3,741 CBC-diff results from samples analyzed between August 2009 and December 2011 in four tertiary care hospitals were included in this study. All samples were anti-coagulated with K₂EDTA, stored at room temperature and tested within 6 hours after collection. Data collected included all the traditional parameters usually reported as part of the CBC-diff, and also all the Cell Population Data (CPD) morphologic parameters, which typically remain stored in the instrument but can be downloaded into an Excel file for analysis. Based on a review of other laboratory tests performed for the individuals enrolled in the study, the individuals were assigned to one of six diagnostic groups. These groups, along with the criteria for inclusion in each group, and the number of patients in each group, are listed in FIG. 9.

FIG. 9A shows CBC parameters (e.g. WBC count, WBC differential, RBC count, Hemoglobin count, and Platelet count) for 12 groups.

2. Development of a Multiparametric Model (Hemeprint) for TB Screening.

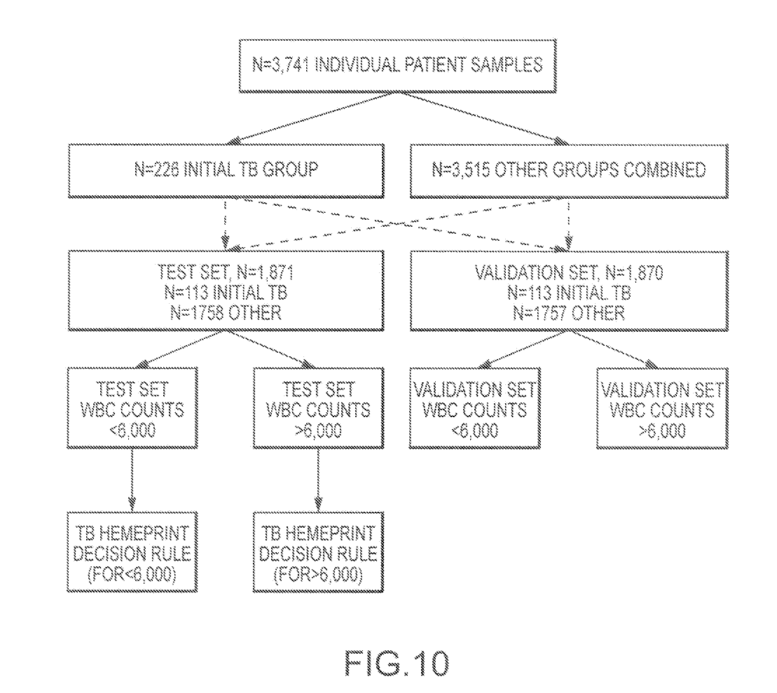

For the development of a TB hemeprint, results from patients in the “Initial TB” group were compared with those of all other groups combined. This analysis was done in a multistep approach, as depicted in FIG. 10. First, the entire sample results (n=3741) were divided into an Initial TB Group (n=226) and an Other Group Combined (n=3515). All patients in both the Initial TB Group and Other Groups Combined Group were then divided into two different data sets. Using the specimen accession number as a guide, each sample was included in either a Test Set or a Validation Set in alternating fashion. Hence, for the Initial TB Group, patients were assigned to either the Test Set (n=113) or the Validation Set (n=113), and for the Other Groups Combined Group, patients were assigned to either the Test Set (n=1758) or the Validation Set (n=1757). Accordingly, the Test Set included 113 Initial TB patient samples and 1758 Other patient samples, and the Validation Set included 113 Initial TB patient samples and 1757 Other patient samples.

In both the Test Set and the Validation Set, patients were divided into those with low WBC counts (<6,000 WBCs/μL) and those with normal/high WBC counts (>6,000 WBCs/μL). This was done because these two groups may have different underlying health conditions associated with TB, and therefore the immunological response in these two scenarios can vary. For example, samples having a WBC count lower than 6,000 per microliter may be associated with individuals more likely to be immunocompromised, whereas samples having a WBC count higher than 6,000 per microliter may be associated with individuals more likely to be immunocompetent.

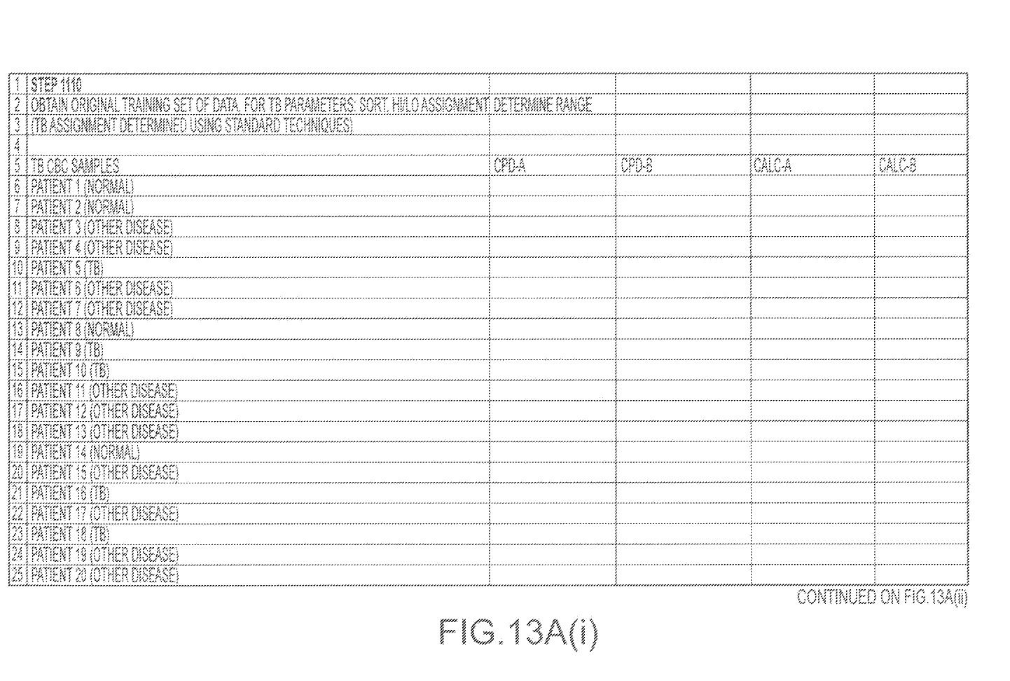

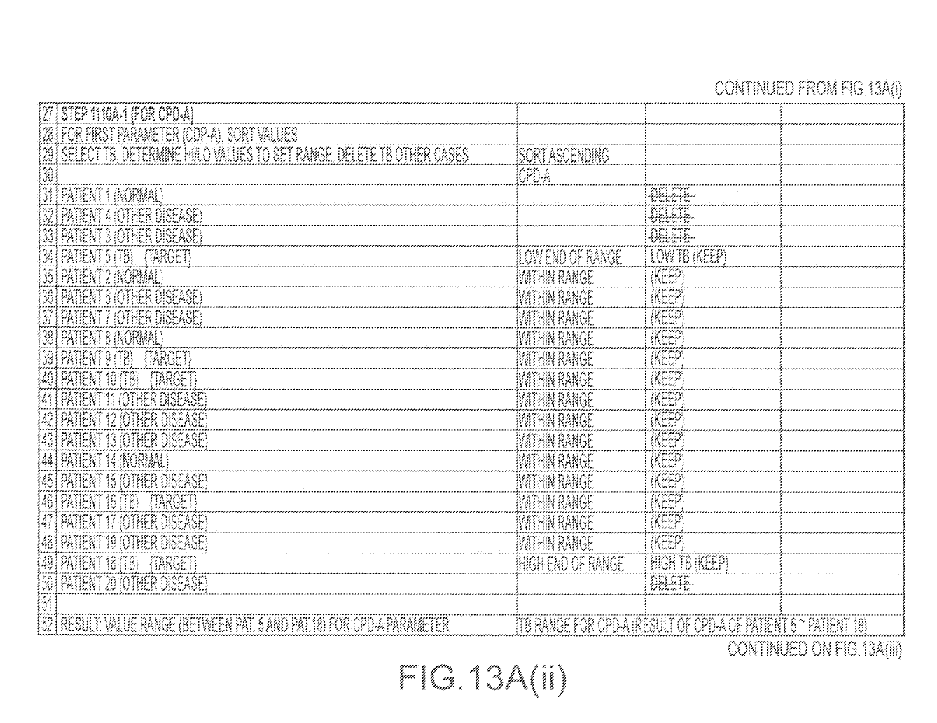

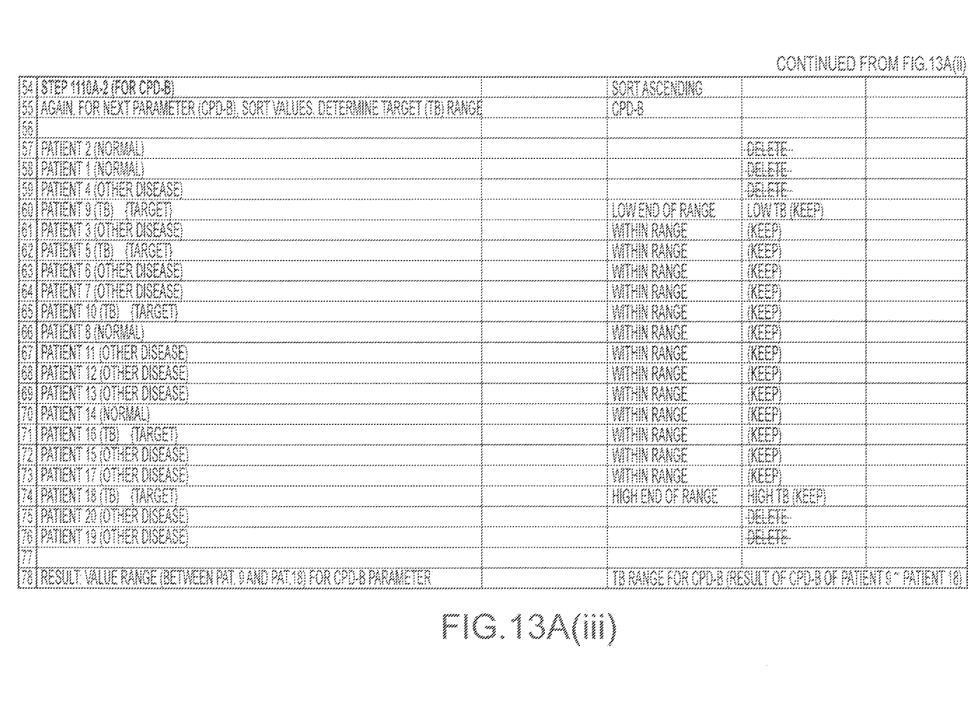

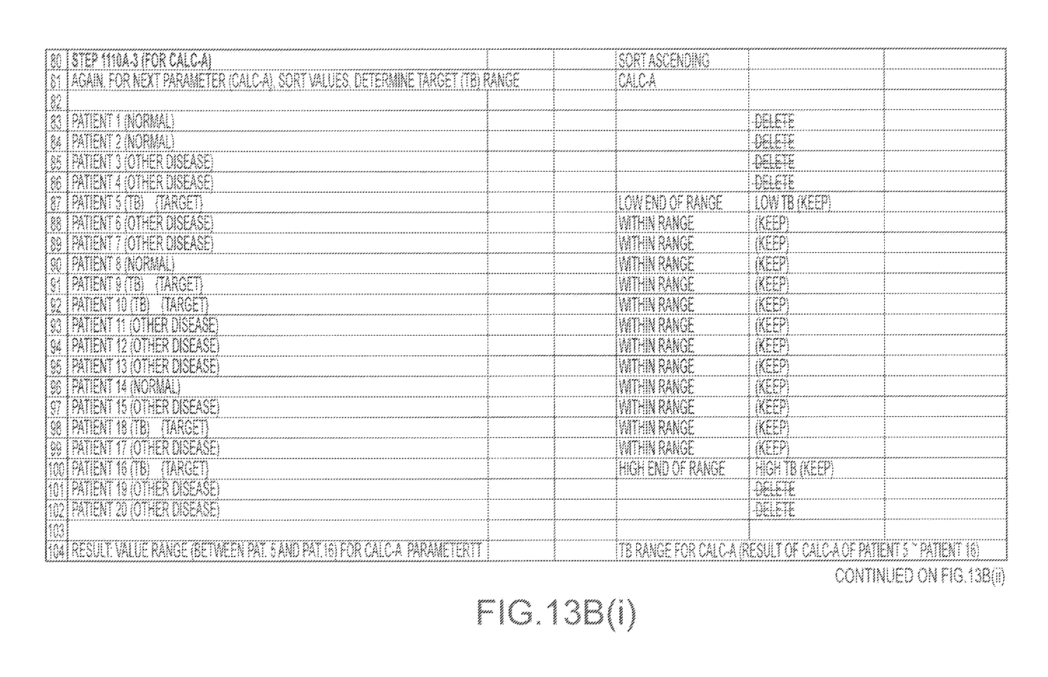

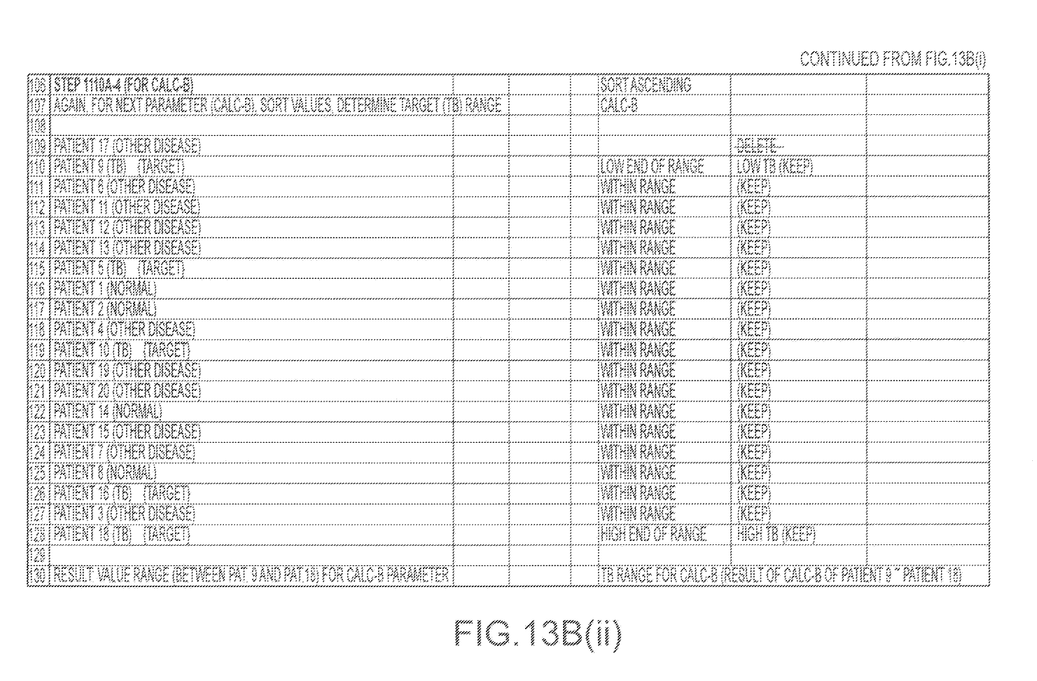

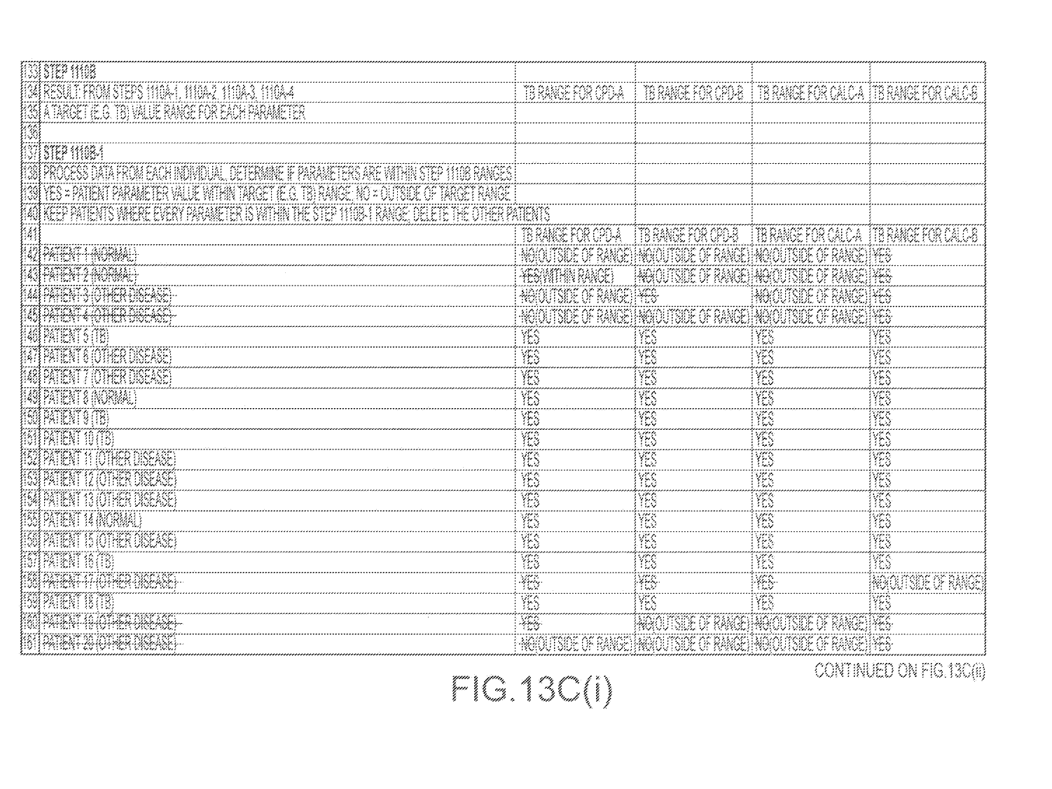

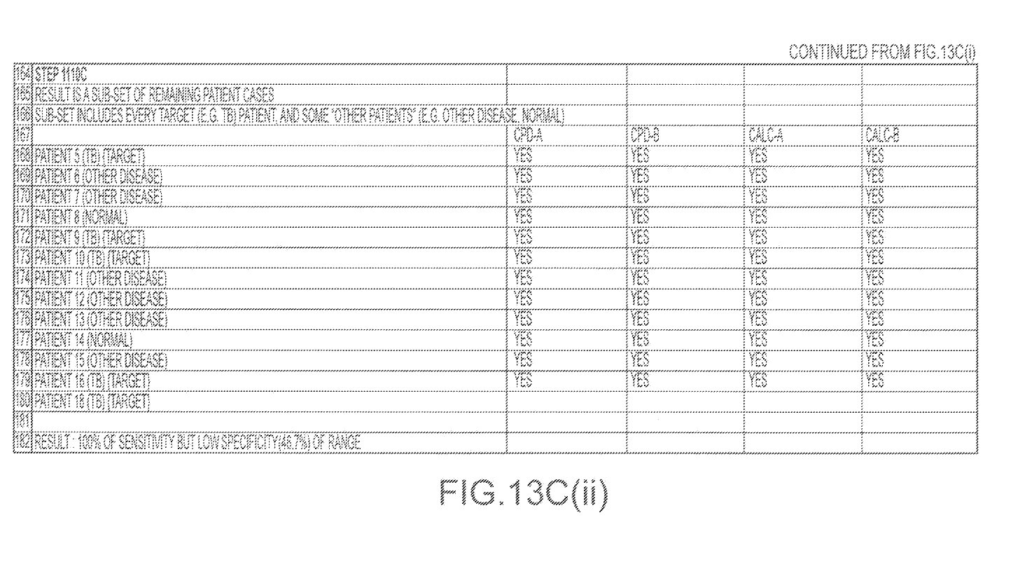

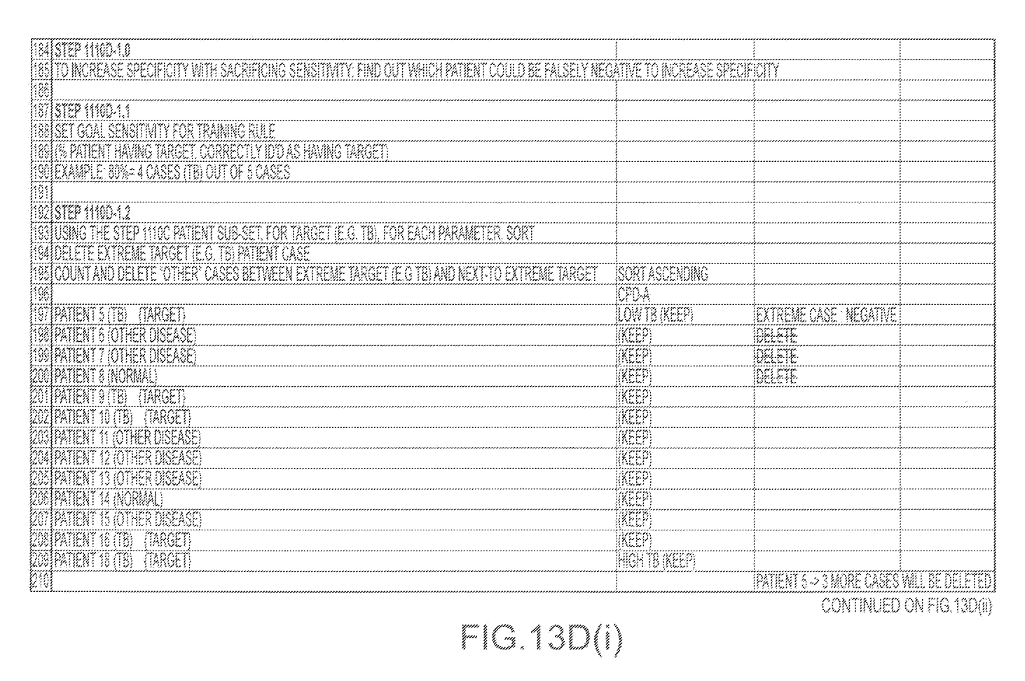

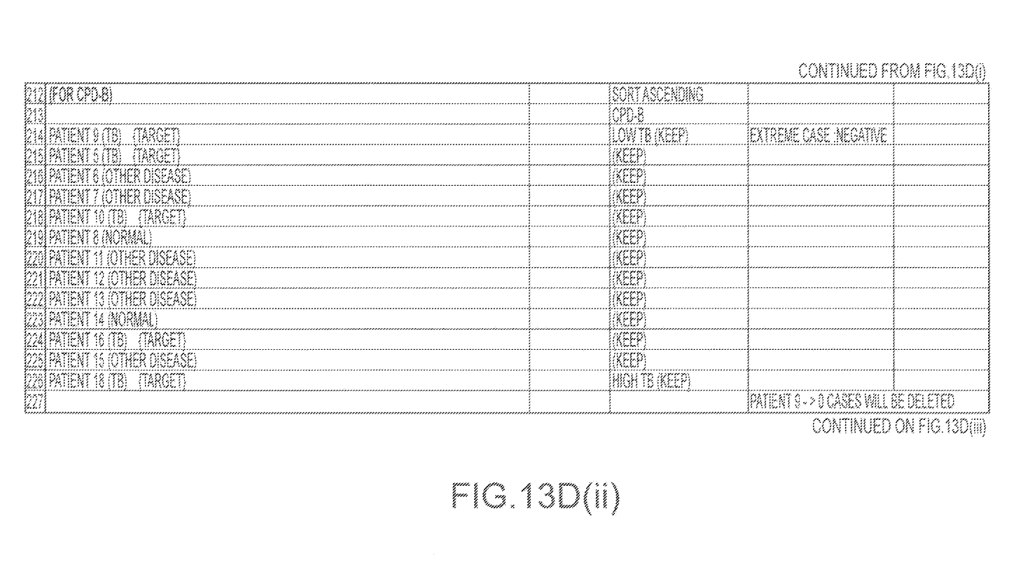

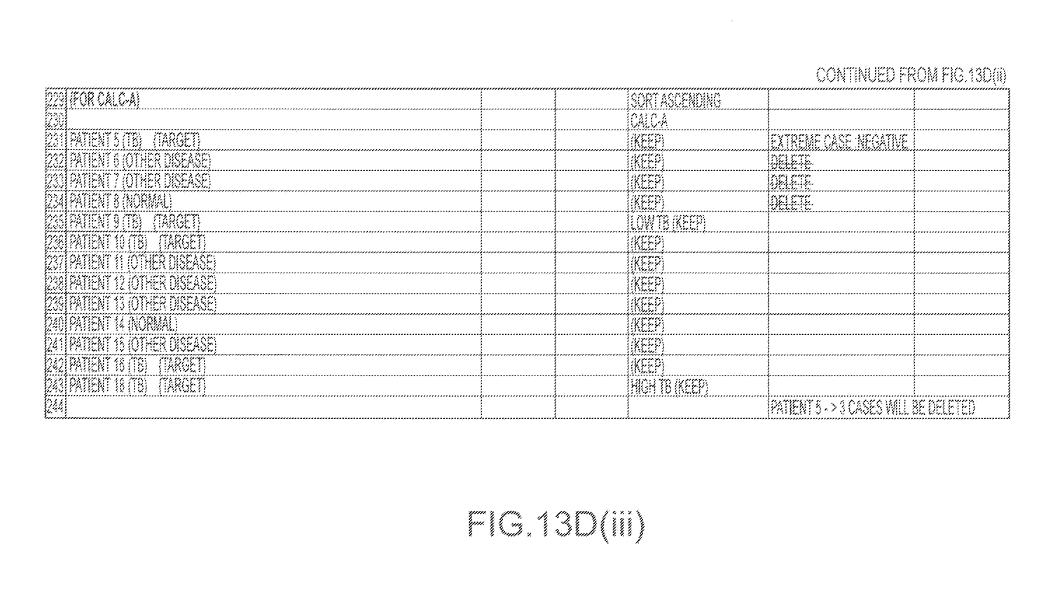

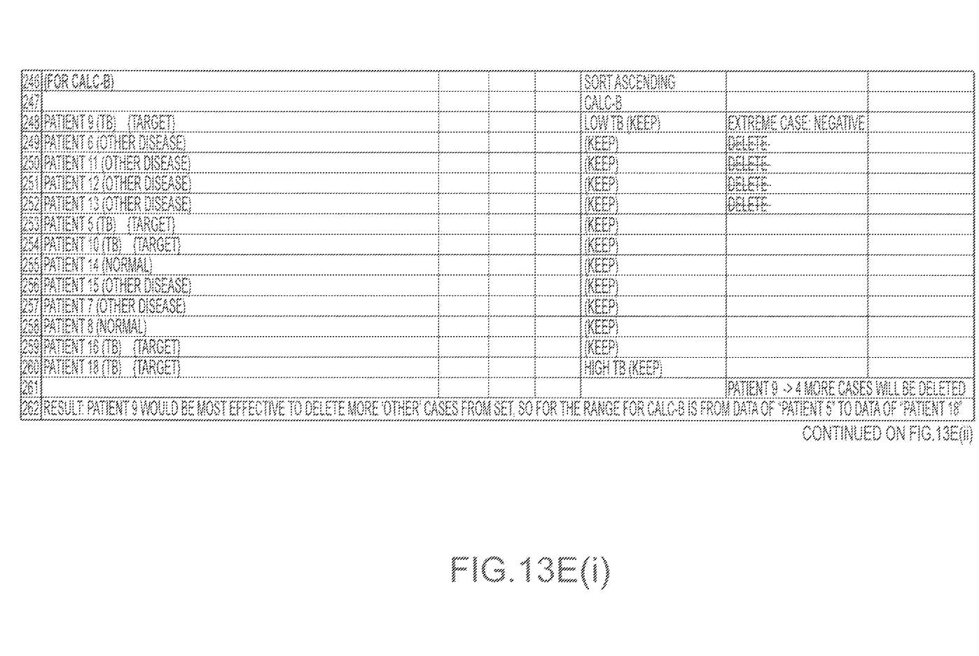

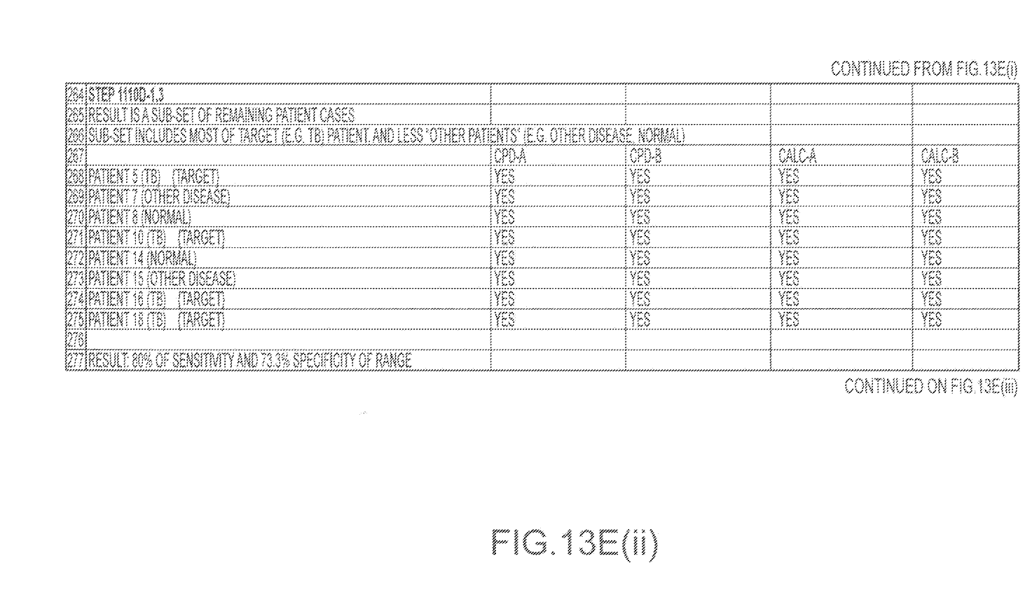

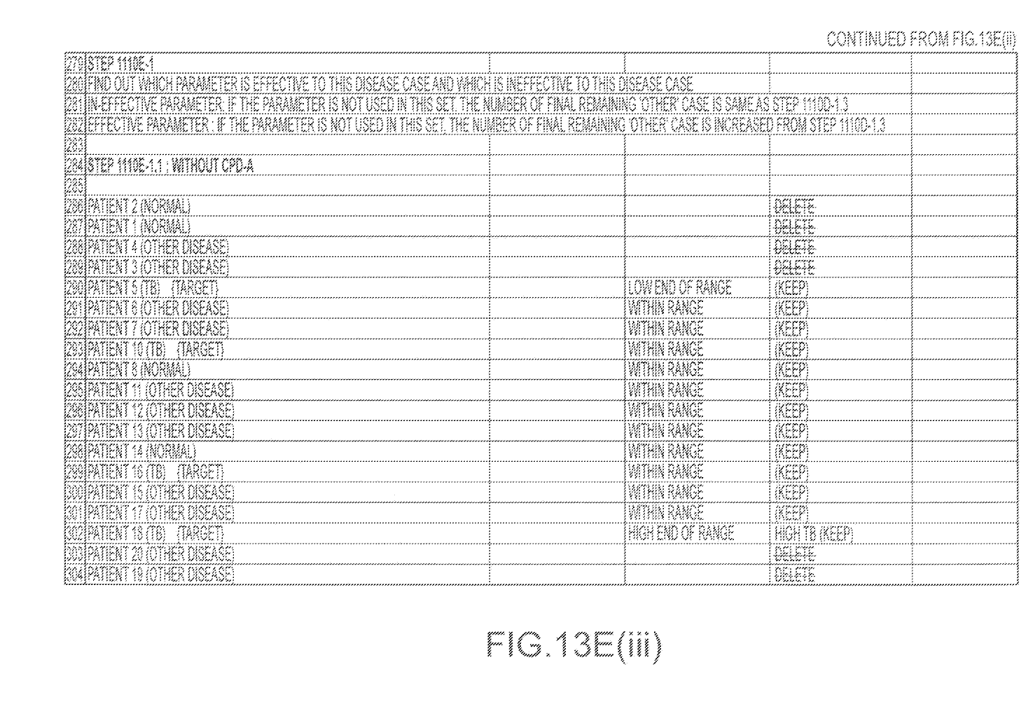

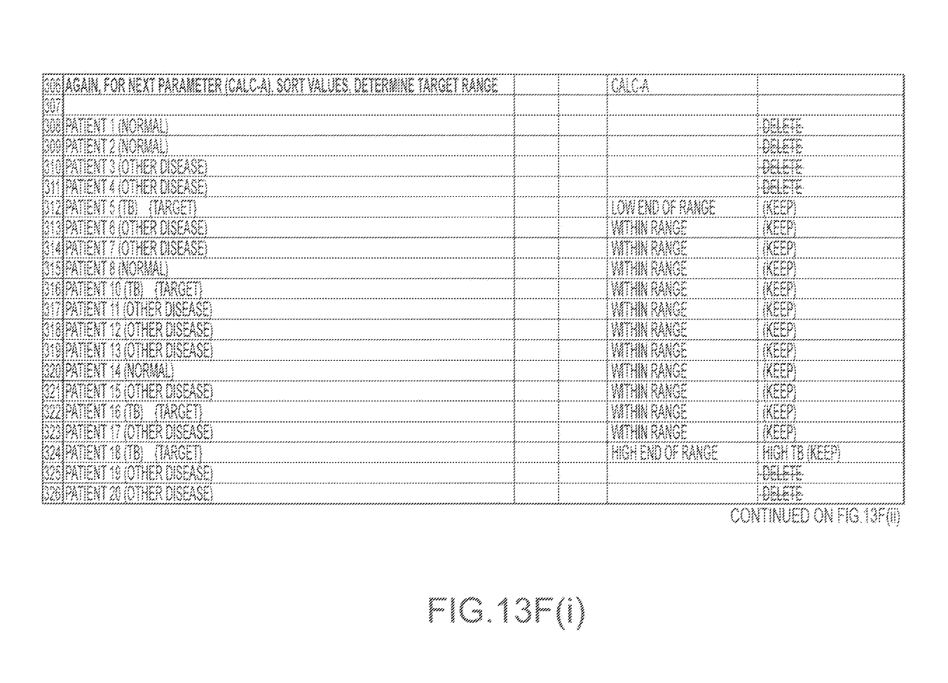

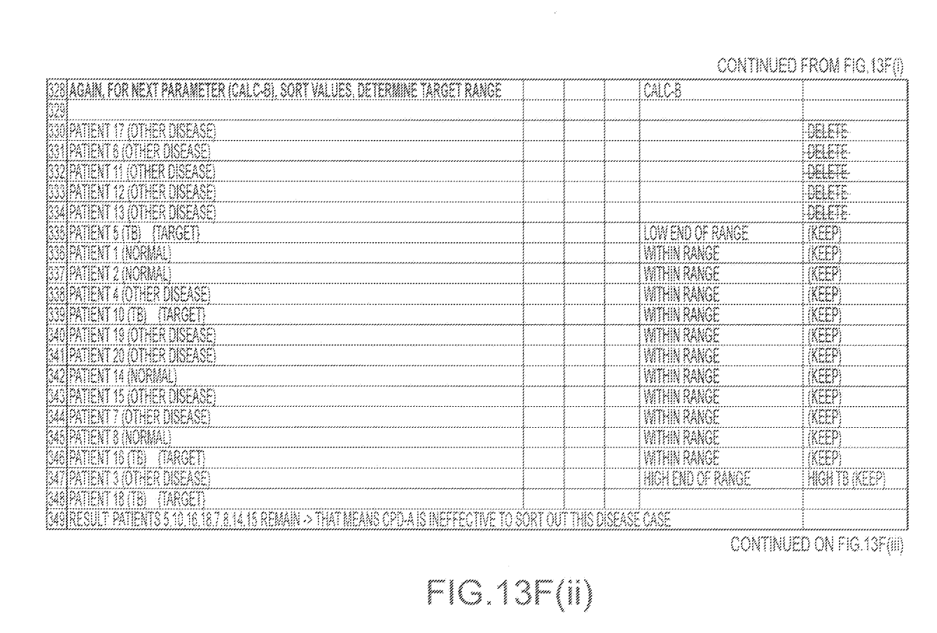

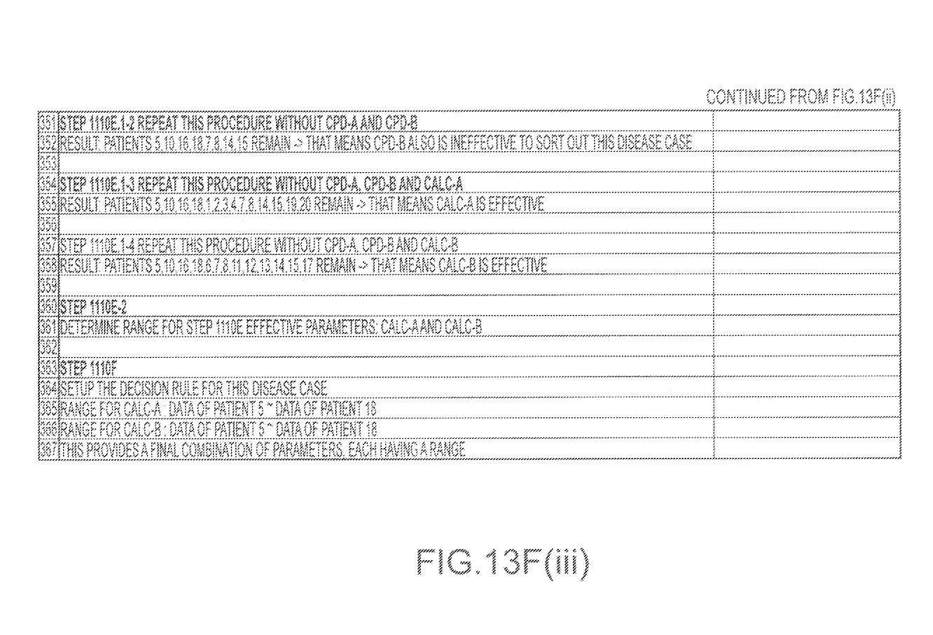

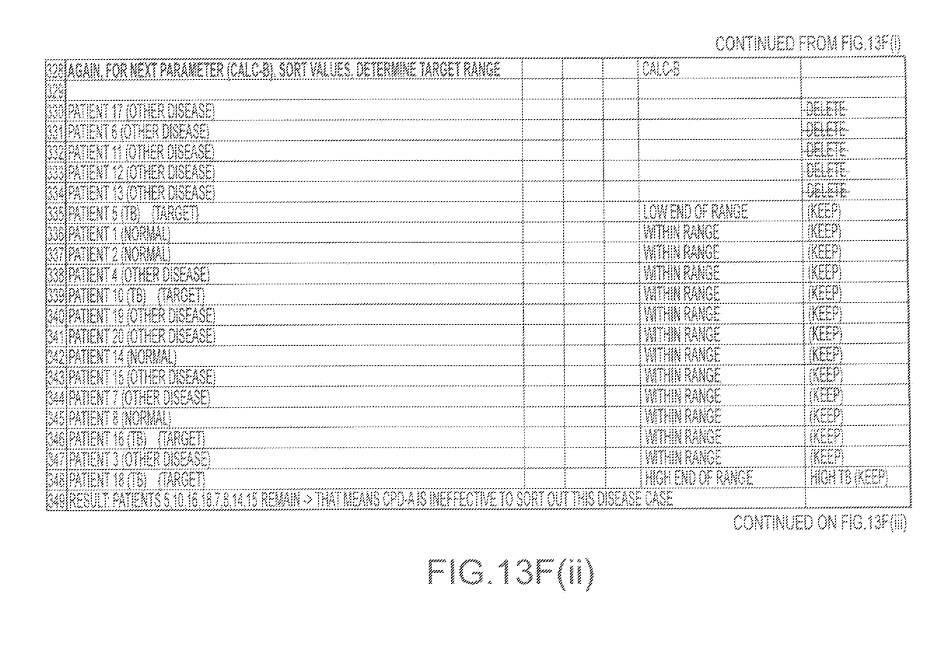

The Test Set of both WBC sub-groups (i.e. <6,000 and >6,000) were evaluated separately. This analysis was done with a software developed for Excel data analysis, which searches for combinations of ranges of parameters that best discriminate TB infection samples from the remainder of the samples. This analysis included both looking at the raw ratio parameter results and developed calculated parameter results. Aspects of this analysis are discussed elsewhere herein (e.g. in relation to FIGS. 13A to 13F).

The two TB hemeprints thus generated (one for low WBC cases and one for normal/high WBC cases) were then applied to the Validation Set data, to test the reproducibility of the hemeprints as applied to a real life laboratory population.

3. Evaluation of the Screening Performance of the TB Hemeprints

The performance of each of the two developed TB hemeprints was then evaluated as follows.

According to some embodiments, the sensitivity, specificity, positive predictive value (PPV) and/or negative predictive value (NPV) for both hemeprints can be calculated, in detecting Initial TB in both the Test Set and the Validation Set. In some cases, the sensitivity and specificity in each group of the population can be used.

Using the results from the sensitivity, specificity, PPV, and/or NPV analysis above, the number of cases that would be flagged for possible TB if these hemeprints were applied in the total study population can be calculated, and the percentage of these cases which would be false positives alarms can also be calculated. In some cases, selected samples may include individuals or populations which could be TB positive. For example, samples may be from TB patients who have been receiving anti-TB medication for a period of time, such as from one day to six months). In some cases, selected samples may be from individuals or populations who are suspected to have TB, but have AFB smear negative results.

In some cases, a TB hemeprints based screening method can be implemented so as to have a workload impact on false positive cases. In some cases, it is possible to evaluate the workload impact by analyzing the number of false positive cases raised by a TB hemeprints approach, per true positive case.

### B. Results

1. TB Hemeprint Model

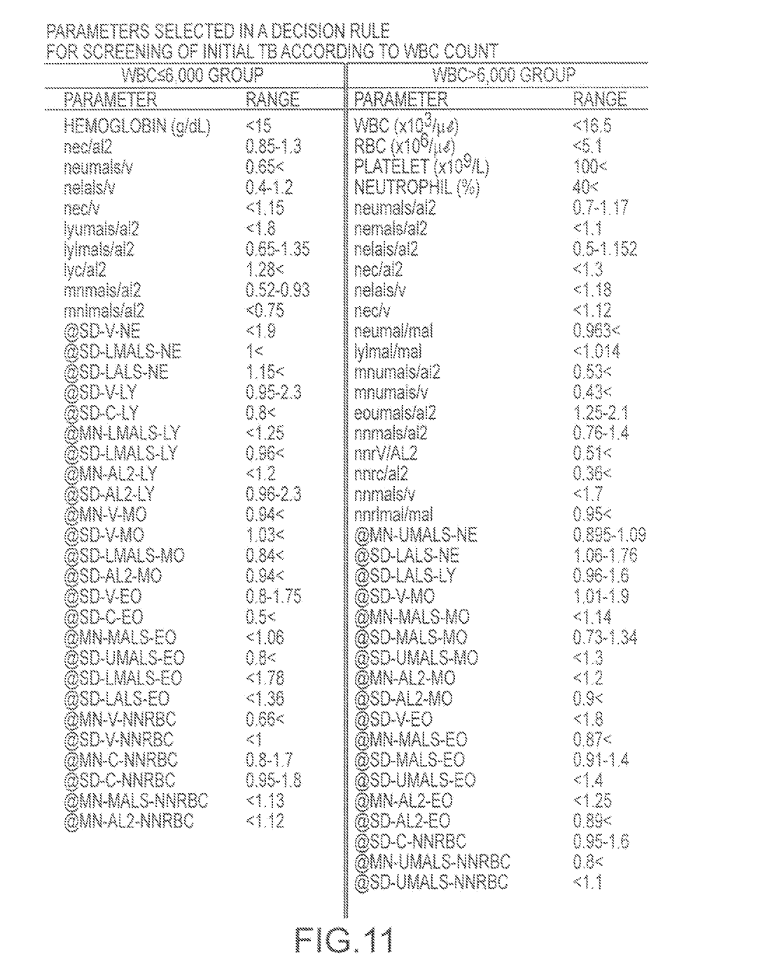

The TB hemeprint for both WBC count groups is shown in FIG. 11. As depicted here, the decisions rules include a combination of calculated parameters, CPD parameters, and traditional CBC parameters. For patients with <6,000 WBCs/μL, the TB hemeprints or decision rule (left column) included a total of 35 criteria that a sample would need to meet to be considered positive. Hence, these parameters proved useful in the discrimination of initial TB from all other samples in the analysis of low WBC count cases.

For patients with >6,000 WBCs/μL, the number of criteria included in the TB hemeprint or decision rule (right column) was 38. These parameters proved useful in the discrimination of initial TB from all other samples in the analysis of normal/high WBC count cases.

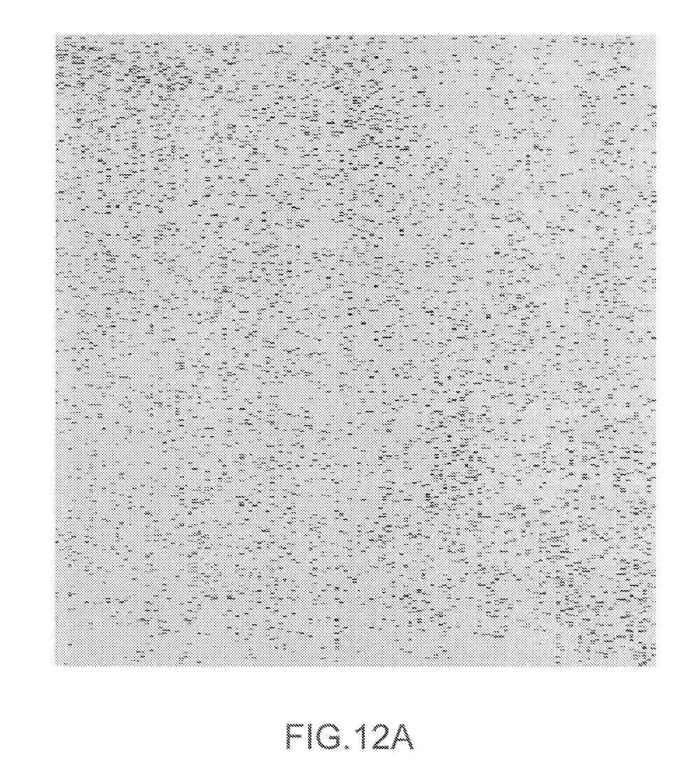

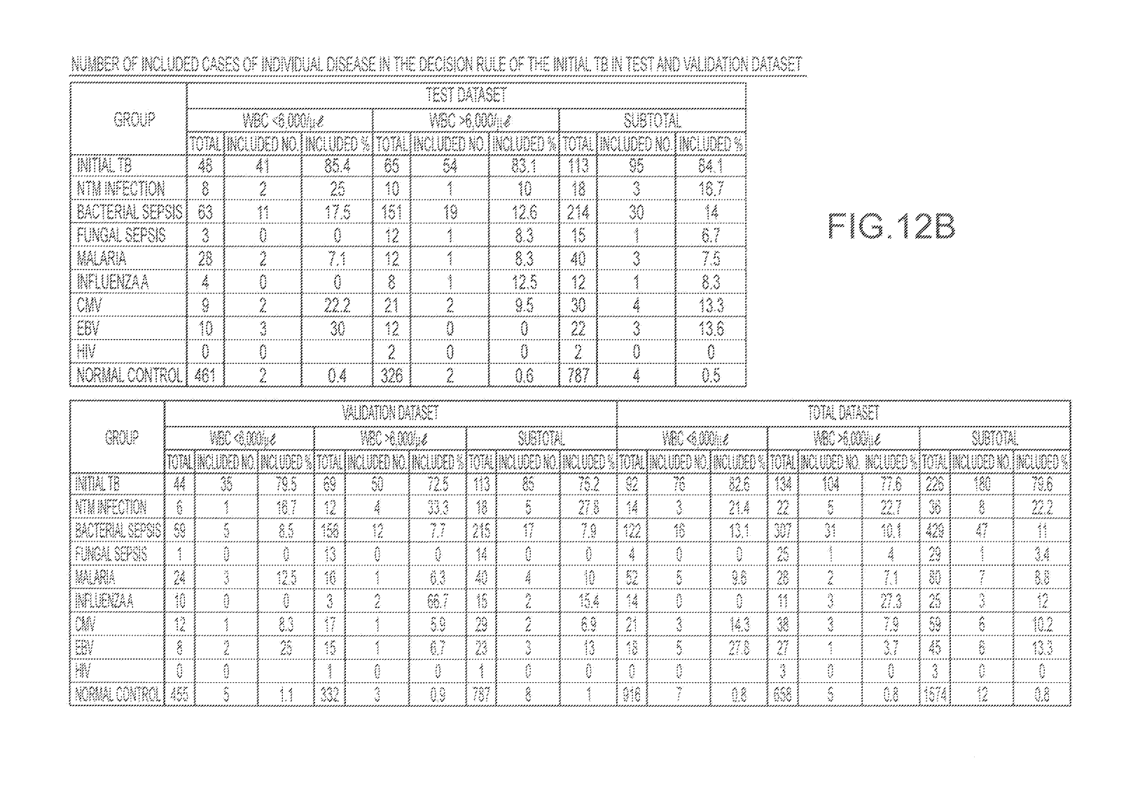

The discrimination power of the model can be visualized in FIG. 12A, showing the clustering of results coming from samples belonging either to the Initial TB group, or all the other groups combined (e.g. cluster analysis type image).

2. Screening Performance of the TB Hemeprint

The table in FIG. 12B shows the number of cases (%) included in the TB decision rule. The positive (false) rate of a normal population was about 1%, and that of other infection groups were higher than a normal control. However, the patients whose blood are flagged as ‘TB’ have other diseases and ‘not healthy’ may not be effective for some patients, because CBC is performed in ‘patients’ except only ‘medical check-up’ group (in the study ‘normal’). The distribution of false positive TB cases per diagnosis can be evaluated, to identify possible TB mimicers. Optionally, such methods can be based on false positive case distributions such as those shown here. In many cases, TB mimicers may be far from being healthy, and even if they did or do not ultimately have TB, it can be beneficial for the patient and the entire health care system if the patient's blood is flagged, because upon deeper diagnostic scrutiny, the patient's correct condition may indeed be identified. In order to identify medical conditions or other clinical diagnosis results most likely to mimic the TB hemeprint, the distribution of the false positive screened cases among the various diagnostic sub-groups can be evaluated. The performance of the TB hemeprint in screening for cases of Initial TB can be calculated as described herein. As mentioned above, FIG. 12B shows the number of cases included in the decision rule for initial TB. The % of initial TB means Sensitivity and that of other populations could be ‘false positive rate’. In some cases, the meaning can be different according to an individual disease population.

a) <6,000 WBCs/μL TB hemeprint in the Test Set

Sensitivity: 85% (41 flagged cases in a total of 48 initial TB cases); Specificity: 89% (780 non-flagged cases in a total of 871 other cases); PPV: 31% (41 initial TB cases in a total of 132 flagged cases); and NPV: 99% (780 other cases in a total of 787 non-flagged cases).

b) <6,000 WBCs/μL TB hemeprint in the Validation Set

Sensitivity: 79% (35 flagged cases in a total of 44 initial TB cases); Specificity: 89% (779 non-flagged cases in a total of 869 other cases); PPV: 28% (35 initial TB cases in a total of 125 flagged cases); and NPV: 98% (779 other cases in a total of 788 non-flagged cases).

c) >6,000 WBCs/μL TB hemeprint in the Test Set

Sensitivity: 83% (54 flagged cases in a total of 65 initial TB cases); Specificity: 85% (759 non-flagged cases in a total of 887 other cases); PPV: 29% (54 initial TB cases in a total of 182 flagged cases); and NPV: 98% (759 other cases in a total of 770 non-flagged cases).

d) >6,000 WBCs/μL TB hemeprint in the Validation Set

Sensitivity:72% (50 flagged cases in a total of 69 initial TB cases); Specificity: 87% (775 non-flagged cases in a total of 888 other cases); PPV:30% (50 initial TB cases in a total of 163 flagged cases); and NPV: 97% (775 other cases in a total of 794 non-flagged cases).

In some cases, hemeprint models can be used for both groups, and in both the test and validation data set, the total number of cases that would be flagged as “suspicious for TB” can be reported. In some cases, those cases that would be expected to be included in the initial TB group, and that could be easily identified clinically, can be removed from the false positives. Accordingly, a false positive may not lean to an unnecessarily increased workload (e.g. such as a TB with medication case, which the clinician may know in advance was TB). In some cases, it is possible to calculate the number of truly false positives samples per newly made diagnosis of TB.

Neutrophils play a role in the response to initial TB infection, and embodiments of the present invention provide diagnostic tools for the evaluation of tuberculosis infection in an individual based on neutrophil morphology. Further, monocytes, lymphocytes, and eosinophils play a role in the response to initial TB infection, and embodiments of the present invention provide diagnostic tools for the evaluation of tuberculosis infection in an individual based on monocyte, lymphocyte, and eosinophil morphology. A hematology system that is equipped to obtain multiple light angle detection parameters, such as Beckman Coulter's UniCel® DxH™ 800 Cellular Analysis System, can be used to implement quantitative and objective morphologic analysis of such cellular components within the blood, so as to evaluate immunologically activated morphologic cell changes in a diagnostically useful manner.

It was observed that CPD changes may not be so pronounced between tuberculosis (TB) and nontuberculous mycobacteria (NTM) infections. However, NTM infections are rare diseases, and even where there is overlap, NTM infections are important medical conditions in their own right, requiring prompt diagnosis. Hence, where NTM cases may be identified by screening methods as disclosed herein, the result may lead to earlier diagnosis and treatment for many patients. It was also observed that CPD changes may be more pronounced between TB and other much more common types of infection that can mimic TB clinically, such as viral, bacterial, and fungal infections. The rate of false positives for these common conditions was not observed to be high, and is not considered to present an impediment to the utilization of the tuberculosis screening techniques discussed herein.

It was observed that use of the TB hemeprint in detecting TB both in the validation and in the test data sets provided excellent results, and the reproducibility of these findings is to be expected. In some instances, quality control methods for the morphologic parameters discussed herein can be employed so that results from different instruments and institutions can be compared and the same hemeprint parameters can be used or otherwise calibrated or correlated in a clinically useful manner. In some instances, multi-centric studies may provide additional information that can be used in evaluating the performance of hemeprints as applied across instruments from different institutions and patient populations.

Embodiments of the present invention encompass systems and methods that implement automated decision rules to trigger a suspect message for TB, for example without involving an actual reporting of hemeprint results or a human interpretation by a clinician. Embodiments of the present invention also encompass techniques for guiding further diagnostic work-ups, for example which may involve performing confirmatory tests for a suspected condition, of symptomatic patients.

Effective Parameters

Embodiments of the present invention encompass systems and methods for determining which parameters to use as effective parameters for a decision rule, and for determining which values or value ranges to use for the effective parameters of the decision rule. In some instances, methods include obtaining data for use in developing the decision rule. Such data can be used as an original training set for developing the decision rule. For example, the data may include CBC, CPD, and/or calculated parameter data for individuals from a general population. Typically, the data for use in developing the decision rule corresponds to information obtained by analyzing the individual's biological sample with a cellular analysis technique as described herein. In this way, the particular physiological state of the individual (e.g. Mycobacterium tuberculosis infection or absence thereof) and the corresponding biological sample data (e.g. CBC, CPD, and/or calculated parameter data) are known. The sum of this data (e.g. full spectrum of values and/or ranges for each parameter) can provide a highly sensitive test. As discussed herein, the method may also include determining a desired sensitivity for a decision rule. Often, a high sensitivity is desired when false negatives are present, and high specificity is desired when false positives are present. Relatedly, high sensitivity is typically desired when a false negative presents a risk to the patient. High sensitivity tests usually have high false positive rates, and when a reduction in false positives is desired, it is helpful to increase the specificity. The sensitivity can be defined as the percentage of individuals having a specific disease, who are correctly identified as having the disease.

FIGS. 13A to 13F depict aspects of an exemplary process for determining which parameters to use as effective parameters for a decision rule, and for determining which values or value ranges to use for the effective parameters of the decision rule. As shown here, the method includes obtaining data for use in developing the decision rule. Such data can be used as an original training set for developing the decision rule. For example, the data may include CBC, CPD, and/or calculated parameter data for individual, including TB patients. Typically, the data for use in developing the decision rule corresponds to information obtained by analyzing the individual's biological sample with a cellular analysis technique as described herein. In this way, the particular physiological state of the individual (e.g. tuberculosis) and the corresponding biological sample data (e.g. CBC, CPD, and/or calculated parameter data) are known. The sum of this data (e.g. full spectrum of values and/or ranges for each parameter) can provide a highly sensitive test. As shown here, the method may also include determining a desired sensitivity for a decision rule. Often, a high sensitivity is desired when false negatives are present, and high specificity is desired when false positives are present. Relatedly, high sensitivity is typically desired when a false negative presents a risk to the patient. High sensitivity tests usually have high false positive rates, and when a reduction in false positives is desired, it is helpful to increase the specificity. The sensitivity can be defined as the percentage of individuals having a specific disease, who are correctly identified as having the disease. Table 3 below provides an exemplary summary for calculating sensitivity, as well as specificity.

TABLE 3

| | Disease Present | Disease Absent |
|---|---|---|
| Test Positive | True Positive (TP) | False Positive (FP) |
| Test Negative | False Negative (FN) | True Negative (TN) |
| Sensitivity | TP/(TP + FN) | |
| Specificity | | TN/(FP + TN) |

By setting a desirable sensitivity, it is possible to increase specificity. For example, where very high specificity is desired for a particular disease, it may be helpful to set the desired sensitivity for the decision rule to a lower value. As shown here, the sensitivity and specificity of the decision rule (e.g. combination of the remaining effective parameters and their corresponding values or value ranges) can be calculated.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

While exemplary embodiments have been described in some detail, by way of example and for clarity of understanding, those of skill in the art will recognize that a variety of modification, adaptations, and changes may be employed. Hence, the scope of the present invention should be limited solely by the claims.

What is claimed is:

1. An automated system for predicting a Mycobacterium tuberculosis infection status in an individual based on a biological sample obtained from blood of the individual, the system comprising:
(a) an optical element having a cell interrogation zone;
(b) a flow path configured to deliver a hydrodynamically focused stream of the biological sample toward the cell interrogation zone;
(c) an electrode assembly configured to measure direct current (DC) impedance and radiofrequency (RF) conductivity of cells of the biological sample passing individually through the cell interrogation zone;
(d) a light source oriented to direct a light beam along a beam axis to irradiate the cells of the biological sample individually passing through the cell interrogation zone; and
(e) a light detection assembly optically coupled to the cell interrogation zone so as to measure light scattered by and transmitted through the irradiated cells of the biological sample, the light detection assembly configured to measure:
(i) a first propagated light from the irradiated cells within a first range of angles relative to the light beam axis;
(ii) a second propagated light from the irradiated cells within a second range of angles relative to the light beam axis, the second range being different than the first range; and
(iii) an axial light propagated from the irradiated cells along the beam axis;
(f) wherein the system is configured to correlate a subset of DC impedance, RF conductivity, the first propagated light, the second propagated light, and the axial light measurements from the cells of the biological sample with a prediction of Mycobacterium tuberculosis infection status in the individual.

2. The system according to claim 1, wherein the light detection assembly comprises a first sensor zone that measures the first propagated light, a second sensor zone that measures the second propagated light, and a third sensor zone that measures the axial propagated light.

3. The system according to claim 1, wherein the light detection assembly comprises a first sensor that measures the first propagated light, a second sensor that measures the second propagated light, and a third sensor that measures the axial propagated light.

4. The system according to claim 1, wherein the subset comprises DC impedance measurements for neutrophils, lymphocytes, monocytes, eosinophils, and non-nucleated red blood cells of the biological sample; or RF conductivity measurements for neutrophils, lymphocytes, eosinophils, and non-nucleated red blood cells of the biological sample.

5. The system according to claim 1, wherein a subset of Complete Blood Cell Count measurements from the cells of the biological sample combined with the subset of DC impedance, RF conductivity, the first propagated light, the second propagated light, and the axial light measurements are correlated with the prediction of Mycobacterium tuberculosis infection status in the individual.

6. The system according to claim 1, wherein the individual has a White Blood Cell Count of less than or equal to 6,000 per microliter of blood, and wherein the subset comprises a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample.

7. The system according to claim 1, wherein the individual has a White Blood Cell Count of greater than 6,000 per microliter of blood, and wherein the subset comprises a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample.

8. The system according to claim 1, wherein the individual has a White Blood Cell Count of less than or equal to 6,000 per microliter of blood, and wherein the subset includes a neutrophil calculated parameter comprising a member selected from the group consisting of:
a ratio of a neutrophil high frequency current measurement to a neutrophil axial light loss measurement,
a ratio of a neutrophil upper median angle light scatter measurement to a neutrophil low frequency current measurement,
a ratio of a neutrophil low angle light scatter measurement to a neutrophil low frequency current measurement, and
a ratio of a neutrophil high frequency current measurement to a neutrophil low frequency current measurement.

9. The system according to claim 1, wherein the individual has a White Blood Cell Count greater than 6,000 per microliter of blood, and wherein the subset includes a neutrophil calculated parameter comprising a member selected from the group consisting of:
a ratio of a neutrophil upper median angle light scatter measurement to a neutrophil axial light loss measurement,
a ratio of a neutrophil median angle light scatter measurement to a neutrophil axial light loss measurement,
a ratio of a neutrophil low angle light scatter measurement to a neutrophil axial light loss measurement,
a ratio of a neutrophil high frequency current measurement to a neutrophil axial light loss measurement,
a ratio of a neutrophil low angle light scatter measurement to a neutrophil low frequency current measurement,
a ratio of a neutrophil high frequency current measurement to a neutrophil low frequency current measurement, and
a ratio of a neutrophil upper median angle light scatter measurement to a neutrophil median angle light scatter measurement.

10. The system according to claim 1, wherein the biological sample comprises:
a blood sample of the individual; or
neutrophils, lymphocytes, monocytes, eosinophils, and non-nucleated red blood cells of the individual.

11. The system according to claim 1, wherein the subset is determined based on a pre-defined specificity and/or sensitivity for tuberculosis.

12. The system according to claim 1, wherein the subset comprises a calculated parameter for identifying tuberculosis.

13. A method for predicting a Mycobacterium tuberculosis infection status in an individual based on a biological sample obtained from blood of the individual, the method comprising:
(a) delivering a hydrodynamically focused stream of the biological sample toward a cell interrogation zone of an optical element;
(b) measuring, with an electrode assembly, current (DC) impedance and radiofrequency (RF) conductivity of cells of the biological sample passing individually through the cell interrogation zone;
(c) irradiating, with a light beam having an axis, cells of the biological sample individually passing through the cell interrogation zone;
(d) measuring, with a light detection assembly, a first propagated light from the irradiated cells within a first range of angles relative to the beam axis;
(e) measuring, with the light detection assembly, a second propagated light from the irradiated cells within a second range of angles relative to the beam axis, the second range being different than the first range;
(f) measuring, with the light detection assembly, axial light propagated from the irradiated cells along the beam axis; and
(g) correlating a subset of DC impedance, RF conductivity, the first propagated light, the second propagated light, and the axial light measurements from the cells of the biological sample with a predicted Mycobacterium tuberculosis infection status of the individual.

14. The method according to claim 13, wherein the light detection assembly comprises a first sensor zone that measures the first propagated light, a second sensor zone that measures the second propagated light, and a third sensor zone that measures the axial propagated light.

15. The method according to claim 13, wherein the light detection assembly comprises a first sensor that measures the first propagated light, a second sensor that measures the second propagated light, and a third sensor that measures the axial propagated light.

16. The method according to claim 13, wherein the subset comprises DC impedance measurements for neutrophils, lymphocytes, monocytes, eosinophils, and non-nucleated red blood cells of the biological sample; or RF conductivity measurements for neutrophils, lymphocytes, eosinophils, and non-nucleated red blood cells of the biological sample.

17. The method according to claim 13, wherein a subset of Complete Blood Cell Count measurements from the cells of the biological sample combined with the subset of DC impedance, RF conductivity, the first propagated light, the second propagated light, and the axial light measurements are correlated with the prediction of Mycobacterium tuberculosis infection status in the individual.

18. The method according to claim 13, wherein the individual has a White Blood Cell Count of less than or equal to 6,000 per microliter of blood, and wherein the subset comprises a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample.

19. The method according to claim 13, wherein the individual has a White Blood Cell Count of greater than 6,000 per microliter of blood, and wherein the subset comprises a calculated parameter based on a function of at least two parameters selected from the group consisting of a high frequency current measurement of the sample, an axial light loss measurement of the sample, an upper median angle light scatter measurement of the sample, a low frequency current measurement of the sample, a low angle light scatter measurement of the sample, a lower median angle light scatter measurement of the sample, and a median angle light scatter measurement of the sample.

20. The method according to claim 13, wherein the individual has a White Blood Cell Count of less than or equal to 6,000 per microliter of blood, and wherein the subset includes a neutrophil calculated parameter comprising a member selected from the group consisting of:
a ratio of a neutrophil high frequency current measurement to a neutrophil axial light loss measurement,
a ratio of a neutrophil upper median angle light scatter measurement to a neutrophil low frequency current measurement,
a ratio of a neutrophil low angle light scatter measurement to a neutrophil low frequency current measurement, and
a ratio of a neutrophil high frequency current measurement to a neutrophil low frequency current measurement.

21. The method according to claim 13, wherein the individual has a White Blood Cell Count greater than 6,000 per microliter of blood, and wherein the subset includes a neutrophil calculated parameter comprising a member selected from the group consisting of:
a ratio of a neutrophil upper median angle light scatter measurement to a neutrophil axial light loss measurement,
a ratio of a neutrophil median angle light scatter measurement to a neutrophil axial light loss measurement,
a ratio of a neutrophil low angle light scatter measurement to a neutrophil axial light loss measurement,
a ratio of a neutrophil high frequency current measurement to a neutrophil axial light loss measurement,
a ratio of a neutrophil low angle light scatter measurement to a neutrophil low frequency current measurement,
a ratio of a neutrophil high frequency current measurement to a neutrophil low frequency current measurement, and
a ratio of a neutrophil upper median angle light scatter measurement to a neutrophil median angle light scatter measurement.

22. The method according to claim 13, wherein the biological sample comprises:
a blood sample of the individual; or
neutrophils, lymphocytes, monocytes, eosinophils, and non-nucleated red blood cells of the individual.

23. The method according to claim 13, wherein the subset is determined based on a pre-defined specificity and/or sensitivity for tuberculosis.

24. The method according to claim 13, wherein the subset comprises a calculated parameter for identifying tuberculosis.

25. An automated method of evaluating a biological sample from an individual, the method comprising:
obtaining, using a particle analysis system, light scatter data, light absorption data, and current data for the biological sample as the sample passes through an aperture;
determining a cell population data profile for the biological sample based on assay results obtained from the particle analysis system;
determining, using a computer system, a predicted Mycobacterium tuberculosis infection status for the individual according to a calculated parameter, wherein the calculated parameter is based on a function of at least two cell population data measures of the cell population data profile; and
outputting the predicted Mycobacterium tuberculosis infection status.

26. An automated system for predicting a Mycobacterium tuberculosis infection status of an individual, the system comprising:
(a) a processor; and
(b) a storage medium comprising a computer application that, when executed by the processor, is configured to cause the system to:
(i) access cell population data concerning a biological sample of the individual;
(ii) use the cell population data to determine a predicted Mycobacterium tuberculosis infection status of the individual; and
(iii) output from the processor information relating to the predicted Mycobacterium tuberculosis infection status.

27. The system according to claim 26, wherein the processor is configured to receive the cell population data as input.

28. The system according to claim 26, wherein the processor, the storage medium, or both, are incorporated within a hematology machine.

29. The system according to claim 28, wherein the hematology machine generates the cell population data.

30. The system according to claim 26, wherein the processor, the storage medium, or both, are incorporated within a computer, and wherein the computer is in communication with a hematology machine.

31. The system according to claim 30, wherein the hematology machine generates the cell population data.

32. The system according to claim 26, wherein the processor, the storage medium, or both, are incorporated within a computer, and wherein the computer is in remote communication with a hematology machine via a network.

33. The system according to claim 32, wherein the hematology machine generates the cell population data.

34. The system according to claim 26, wherein the cell population data comprises a member selected from the group consisting of an axial light loss measurement of the sample, a light scatter measurement of the sample, and a current measurement of the biological sample.

35. An automated method for predicting a Mycobacterium tuberculosis infection status of an individual, the method comprising:
(a) accessing cell population data concerning a biological sample of the individual by executing, with a processor, a storage medium comprising a computer application;
(b) using the cell population data to determine a predicted Mycobacterium tuberculosis infection status of the individual by executing, with the processor, the storage medium; and
(c) outputting from the processor information relating to the predicted Mycobacterium tuberculosis infection status.

36. The method according to claim 35, wherein the processor is configured to receive the cell population data as input.

37. The method according to claim 35, wherein the processor, the storage medium, or both, are incorporated within a hematology machine.

38. The system according to claim 37, wherein the hematology machine generates the cell population data.

39. The method according to claim 35, wherein the processor, the storage medium, or both, are incorporated within a computer, and wherein the computer is in communication with a hematology machine.

40. The system according to claim 39, wherein the hematology machine generates the cell population data.

41. The method according to claim 35, wherein the processor, the storage medium, or both, are incorporated within a computer, and wherein the computer is in remote communication with a hematology machine via a network.

42. The system according to claim 41, wherein the hematology machine generates the cell population data.

43. The method according to claim 35, wherein the cell population data comprises a member selected from the group consisting of an axial light loss measurement of the sample, a light scatter measurement of the sample, and a current measurement of the biological sample.
